(19) United States
(12) Patent Application Publication
(10) Pub. No.: US 2015/0206444 A1
(43) Pub. Date: Jul. 23, 2015

(54) SYSTEM AND METHOD FOR AUTHORING ANIMATED CONTENT FOR WEB VIEWABLE TEXTBOOK DATA OBJECT

(71) Applicant: Zyante, Inc., Los Gatos, CA (US)

(72) Inventors: Frank Vahid, Los Gatos, CA (US); Alex Edgcomb, Los Gatos, CA (US); Sarah Strawn, Los Gatos, CA (US)

(21) Appl. No.: 14/603,272

(22) Filed: Jan. 22, 2015

Related U.S. Application Data
(60) Provisional application No. 61/930,792, filed on Jan. 23, 2014.

(51) Int. Cl. G09B 5/02; G06F 3/0483; G06F 3/0484; G06T 13/00

(52) U.S. Cl. CPC G09B 5/02; G06T 13/00; G06F 3/0483; G06F 3/04845; G06T 2213/08

(57) ABSTRACT

An apparatus for creating or modifying browser-renderable teaching objects for use in creating a browser-renderable textbook data object. The apparatus includes a database, a network interface for receiving a source file containing codes for creating or modifying the browser-renderable teaching objects by way of a network, and a processor configured to create or modify the teaching objects based on the codes, and store the teaching objects in the database. A first code instructs the processor to create at least one browser-renderable section object for the textbook data object, the first code including a first attribute configured to instruct the processor to configure the at least one section object such that, when rendered by a browser module, a specified section title is provided at a beginning of the at least one section object; and (2) set of codes configured to instruct the processor to create or modify the teaching objects within the at least one section object.

### CROSS REFERENCE TO RELATED APPLICATION

This application claims the benefit of the filing date of Provisional Application, Ser. No. 61/930,792, filed on Jan. 23, 2014, entitled, “SYSTEM AND METHOD FOR FACILITATING TEACHING, LEARNING, ASSESSMENT, AND EDUCATIONAL CONTENT CONTRIBUTION,” which is incorporated herein by reference.

This application is also related to Non-Provisional application, entitled “SYSTEM AND METHOD FOR AUTHORING CONTENT FOR WEB VIEWABLE TEXTBOOK DATA OBJECT,” filed concurrently with this application. This related Non-Provisional application is incorporated herein by reference.

### FIELD

This disclosure relates generally to educational systems, apparatuses, and methods, and in particular, to a system and method for facilitating teaching, learning, assessment, and educational content contribution.

### BACKGROUND

Traditional learning tools, such as textbooks, are often not conducive to provide students a fruitful and interesting learning experience. This is generally because traditional textbooks include learning content that is passive. In other words, traditional textbooks typically include substantial amount of text, which requires reading and concentration by students to understand the subject matter being taught. Additionally, traditional textbooks further includes static pictures, diagrams, tables, and other static visual items designed to teach the associated subject matter to the students.

Because many concepts being taught require motion, such as the operation of a motor, such concepts are difficult to get across to students using static content typically used by traditional textbooks. Further, even though some concepts being taught do not necessarily require motion, often it is easier for the understanding of the students to demonstrate such concepts in a motion based teaching content. Teachers often compensate for the limitations of traditional textbooks by providing an interactive teaching environment in classrooms. However, teachers generally have a relatively small amount of classroom time to provide students such interactive teaching environment.

Another drawback of traditional textbooks is that they are generally static and not easily amenable to updating. This is a significant drawback in the case where the subject matter is undergoing significant changes. Generally, the typical manner of updating traditional textbooks is by issuing updates or new editions to the textbooks every few years, again which may be a significant drawback if the associated subject matter is undergoing changes.

Yet, another drawback of traditional textbooks is that they are often authored by a single author or a small number of authors. Thus, the subject matters of such textbooks is based on the interpretation of small amount of authors. Having more authors contribute to the subject matter of textbooks or enabling all user to easily provide feedback would generally improve the teaching and accuracy of the associated subject matters.

### SUMMARY

An aspect of the disclosure relates to an apparatus for creating or modifying browser-renderable teaching objects for use in creating a browser-renderable textbook data object. The apparatus comprises a database, a network interface for receiving a source file comprising codes for creating or modifying the browser-renderable teaching objects by way of a network, and a processor configured to create or modify the browser-renderable teaching objects based on the received codes, and store the browser-renderable teaching objects in the database.

The codes comprise: (1) a first code configured to instruct the processor to create at least one browser-renderable section object for the browser-renderable textbook data object, wherein the first code includes a first attribute configured to instruct the processor to configure the at least one section object such that, when rendered by a browser module, a specified section title is provided at a beginning of the at least one section object; and (2) a set of codes configured to instruct the processor to create or modify of the plurality of browser-renderable teaching objects within the at least one section object.

In another aspect of the disclosure, the codes further comprise a second code configured to instruct the processor to create or modify at least one chapter object for the textbook data object, wherein the at least one section object is within the at least one chapter object, and wherein second code includes a first attribute configured to instruct the processor to configure the at least one chapter object such that, when rendered by the browser module, a specified chapter title is provided at a beginning of the at least one chapter object.

In another aspect of the disclosure, the processor is configured to create or modify the at least one chapter object such that, when rendered by the browser module, an input data object is provided within the at least one chapter object for receiving feedback regarding the at least one chapter object from a viewing user accessing the textbook data object via the browser module.

In another aspect of the disclosure, the processor is configured to create or modify a browser-renderable navigation object or a browser-renderable table-of-content object for the textbook data object such that, when rendered by the browser module, the navigation object or the table-of-content object comprises a hyperlink for navigating to the beginning of the at least one chapter object. In another aspect, the second code includes a second attribute configured to instruct the processor to configure the hyperlink with a specified name. In yet another aspect, the second code includes a third attribute configured to instruct the processor to configure the at least one chapter object such that, when rendered by the browser module, a specified chapter number is provided at the beginning of the at least one chapter object. In still another aspect, the third attribute is configured to instruct the processor to configure the name of the hyperlink to further include the specified chapter number.

In another aspect of the disclosure, the processor is configured to automatically modify the at least one chapter object or the at least one section object in response to organizational changes to the textbook data object, such that when rendered by the browser module, at least one chapter number is rendered to identify the at least one chapter object or at least one section number is rendered to identify the at least one section, wherein the at least one chapter number is based on a sequential order of the at least one chapter object in the textbook data object or wherein the at least one section number is based on a sequential order of the at least one section object within the at least one chapter object.

In another aspect of the disclosure, wherein the processor is configured to create or modify the at least one section object such that, when rendered by the browser module, an input data object is provided within the at least one section object for receiving feedback regarding the at least one section object from a viewing user accessing the textbook data object via the browser module.

In another aspect of the disclosure, the processor is configured to create or modify a browser-renderable navigation object or a browser-renderable table-of-content object for the textbook data object such that, when rendered by the browser module, the navigation object or the table-of-content object comprises a hyperlink for navigating to the beginning of the at least one section object. In another aspect, the first code includes a second attribute configured to instruct the processor to configure the hyperlink with a specified name. In still another aspect, the first code is configured to instruct the processor to configure the name of the hyperlink to further include a section number related to an order in which the at least one section object is positioned within a chapter object.

In another aspect of the disclosure, the processor is configured to create or modify the at least one of the teaching objects such that, when rendered by the browser module, an input data object is provided for receiving feedback regarding the at least one teaching object from a viewing user accessing the textbook data object via the browser module. In another aspect, the set of codes are configured to instruct the processor to configure at least one of the teaching objects such that, when rendered by the browser module, a specified term or term definition is provided with a defined text attribute, wherein the processor is further configured to create or modify a browser-renderable glossary object for the textbook data object such that, when rendered by the browser module, the glossary object comprises a hyperlink for navigating to the specified term or term definition in the teaching object, wherein the hyperlink is identified by the specified term or term definition.

In another aspect of the disclosure, the set of codes are configured to instruct the processor to configure at least one of the teaching objects as a question set object such that, when rendered by the browser module, at least one input object is provided for receiving an answer from a viewing user accessing the textbook data object via the browser module. In another aspect, the set of codes are configured to instruct the processor to configure the question set object such that, when rendered by the browser module, a visual indication is provided as to whether the answer from the viewing user was correct or incorrect.

In another aspect of the disclosure, the set of codes are configured to instruct the processor to configure the question set object such that, when rendered by the browser module, a hint is provided in response to the incorrect answer from the viewing user. In another aspect, the set of codes are configured to instruct the processor to configure the question set object such that, when rendered by a browser module, an explanation for the correct answer is provided.

In another aspect of the disclosure, the question set object is configured as one or more of the following: (1) a true or false type question set object; (2) a fill-in-the-blank type question set object; (3) a multiple choice type question set object; (4) a matching type question set object; (5) a detect answer type question set object; and (6) a survey question set object.

In another aspect of the disclosure, the set of codes are configured to instruct the processor to configure at least one of the teaching objects as a drawing object or image object such that, when rendered by the browser module, the drawing or image is displayed. In another aspect, the set of codes are configured to instruct the processor to configure at least one of the teaching objects as a mathematical equation object such that, when rendered by the browser module, a mathematical equation is displayed. In still another aspect, the set of codes related to the mathematical equation object comprise a LaTex mathematical equation.

In yet another aspect, the set of codes are configured to instruct the processor to configure at least one of the teaching objects such that, when rendered by the browser module, a hyperlink is provided to an external teaching object, where the browser module is configured to render the external teaching object in response to a viewing user selecting the hyperlink.

In another aspect of the disclosure, the set of codes are configured to instruct the processor to configure at least one of the teaching objects such that, when rendered by the browser module, an animated teaching object configured to generate an animation is provided. In another aspect, the animated teaching object, when rendered by the browser module, provides one or more of the following: (1) an input object to allow a viewing user to initiate the animation; and (2) one or more input objects to initiate one or more scenes of the animation, respectively.

In another aspect of the disclosure, the source file is simultaneously editable by different users. In another aspect, the processor is configured to create one or more other textbook data objects that include at least a portion of the teaching objects. In still another aspect, the textbook data object is configured such that an abbreviated version of the textbook data object is rendered by the browser module in response to an input from the user or a pre-configured setting. In yet another aspect, the textbook data object is configured such that a version for visually-impaired users of the textbook data object is rendered by the browser module in response to an input from the user or a pre-configured setting.

In another aspect of the disclosure, the processor is configured to create or modify the textbook data object such that, when rendered by the browser module, provides an input object for receiving notes from the user viewing the textbook data object via the browser module, and wherein the processor is further configured to modify the textbook data object based on the notes.

Another aspect of the disclosure relates to an apparatus for rendering a textbook data object. The apparatus comprises a display, a network interface, and a processor configured to execute a browser module configured to access a textbook source file by way of the network interface, and interpret rendering codes in the textbook source file to render the textbook data object on the display. The rendering codes comprises: (1) a first code configured to instruct the browser module to render at least one chapter object of the textbook data object on the display, wherein the first code includes a first attribute configured to instruct the browser module to render a specified chapter title at a beginning of the at least one chapter object; (2) a second code configured to instruct the browser module to render at least one section object within the at least one chapter in the textbook data object on the display, wherein the second code includes a first attribute configured to instruct the browser module to render a specified section title at a beginning of the at least one section object; and (3) a set of codes configured to instruct the browser module to render a plurality of teaching objects within the at least one section object of the textbook data object on the display.

Another aspect of the disclosure relates to an apparatus for creating or modifying a source file comprising codes for instructing an authoring module how to create browser-renderable teaching objects including a question set object. The apparatus comprises a user interface; and a processor configured to: (1) instruct the user interface to display a first input object configured to receive one or more inputs from a user for specifying a type for the question set object; (2) instruct the user interface to display a second input object for receiving one or more inputs from the user for specifying one or more questions for the question set object; (3) instruct the user interface to display a third input object for receiving one or more inputs from the user for specifying one or more answers to the one or more questions for the question set object; and (4) generate the codes pertaining to the question set object based on the one or more inputs received by way of the first, second, and third input objects.

In another aspect of the disclosure, the processor is configured to: (1) instruct the user interface to display a fourth input object for receiving one or more inputs from the user for specifying one or more hints regarding one or more correct answers to the one or more questions; and (2) generate the codes pertaining to the question set object further based on the one or more inputs received by way of the fourth input object.

In another aspect of the disclosure, the processor is configured to: (1) instruct the user interface to display a fourth input object for receiving one or more inputs from the user for specifying one or more explanations regarding one or more correct answers to the one or more questions; and (2) generate the codes pertaining to the question set object further based on the one or more inputs received by way of the fourth input object.

Another aspect of the disclosure relates to an apparatus for creating or modifying a source file comprising codes for instructing an authoring module how to create browser-renderable teaching objects including a browser-renderable animated teaching object configured to generate an animation. The apparatus comprises a user interface; and a processor configured to: (1) instruct the user interface to display a first input object configured to receive one or more inputs from a user to create one or more animation objects pertaining to the animated teaching object; (2) instruct the user interface to display a second input object for receiving one or more inputs from the user to create one or more animation instructions for the one or more animation objects pertaining to the animated teaching object; and (3) generate the codes associated with the one or more animation objects and the one or more animation instructions.

In another aspect of the disclosure, the processor is configured to instruct the user interface and generate the codes under a control of a browser module. In another aspect, the processor is further configured to instruct the user interface to display the generated codes for copying and pasting to the source file. In yet another aspect, the processor is configured to create or modify the source file based on the generated codes.

In another aspect of the disclosure, the one or more animation objects comprises a text object including text. In another aspect, the processor is configured to instruct the user interface to display a third input object for receiving one or more inputs from the user to set one or more attributes of the text object. In yet another aspect, the one or more attributes of the text object comprises one or more of the following: (1) a background color for a background upon which the text is overlaid; (2) a border color for a border surrounding the text; (3) an opacity for the text object; (4) a radius of corners of the border surrounding the text; (5) a position of the text object within a preview animation pane displayed by the user interface; (6) a font color for the text; (7) a font size for the text; (8) a font family for the text; (9) a text alignment for the text; and (10) a setting indicating whether to the text is italicized.

In another aspect of the disclosure, the one or more animation objects comprises a graphics object including a graphics design. In another aspect, the processor is configured to instruct the user interface to display a third input object for receiving one or more inputs from the user to set one or more attributes of the graphics object. In still another aspect, the one or more attributes of the text object comprises one or more of the following: (1) a background color for a background upon which the graphics design is overlaid; (2) a border color for a border surrounding the graphics design; (3) an opacity for the graphics object; (4) a radius of corners of the border surrounding the graphics design; and (5) a position of the graphics object within a preview animation pane displayed by the user interface.

In another aspect of the disclosure, the one or more animation instructions comprises a move instruction for one of the animation object. In another aspect, the processor is configured to instruct the user interface to display a third input object for receiving one or more inputs from the user of an amount of movement of the animation object pursuant to the move instruction. In still another aspect, the third input object comprises: (1) a first input sub-object to receive a first value indicating a horizontal position within a preview animation pane to which the animation object is to be moved pursuant to the move instruction; and (2) a second input sub-object to receive a second value indicating a vertical position within the preview animation pane to which the animation object is to be moved pursuant to the move instruction. In yet another aspect, the processor is configured to detect a select and drag of the animation object and a subsequent unselecting of the animation object by a pointing device of the user interface, wherein the move instruction comprises moving the animation object to a position of the animation object at the unselecting of the animation object.

In another aspect of the disclosure, the one or more animation instructions comprises a fade instruction for one of the animation object. In another aspect, the processor is configured to instruct the user interface to display a third input object for receiving one or more inputs from the user of a degree of opacity for the animation object pursuant to the fade instruction.

In another aspect of the disclosure, the one or more animation instructions comprises a resize instruction for one of the animation object. In another aspect, the processor is configured to instruct the user interface to display a third input object for receiving one or more inputs from the user of first and second values indicating a new height and a new width for the animation object pursuant to the resize instruction.

In another aspect of the disclosure, the processor is configured to instruct the user interface to display a list of animation instructions in chronological order of execution pursuant to the animation. In another aspect, the processor is configured to instruct the user interface to display a third input object for receiving one or more inputs from the user of a timing parameter associated with each of the animation instruction, the timing parameter specifying a timing for the execution of the corresponding animation instruction pursuant to the animation. In still another aspect, the processor is configured to instruct the user interface to display a third input object for receiving one or more inputs from the user for indicating a first set of the chronological animation instructions belonging to a first scene and a second set of the chronological animation instructions belonging to a second scene, wherein the animation is configured to stop at an end of the first scene and requires an input from a user to initiate a start of the second scene.

In another aspect of the disclosure, the processor is configured to instruct the user interface to display a static view of the animation in an animation preview pane in response to a selection action by the user of one of the animation instructions of the list, wherein the static view depicts the animation immediately after the execution of the selected animation instruction. In another aspect, the processor is configured to instruct the user interface to display a third input object in response to a selection action by the user of one of the animation instructions of the list, wherein the third input object is configured to receive one or more inputs from the user of at least one attribute of the selected animation instruction.

In another aspect of the disclosure, the processor is configured to instruct the user interface to display a list of one or more references to the one or more animation objects, respectively. In another aspect, the list includes references to a plurality of the animation objects illustrated as being stacked in a preview animation pane, and wherein an order of the references to the stacked objects are from most foreground to most background or from most background to most foreground.

In still another aspect, the processor is configured to detect a select and drag of one of the references to the stacked animation objects within the list and a subsequent unselecting of the one of the references within the list by a pointing device of the user interface, the processor configured to instruct the display to change the viewing of the corresponding one of the stacked animation object based on a position within the list at which the unselecting of the one of the references was detected. In yet another aspect, the processor is configured to detect a selection of one of the animation object by detecting a selection of the reference to the one of the animation object or by detecting a selection on the animation object in a preview animation pane.

In another aspect of the disclosure, the codes are configured to instruct the authoring module to configure the animated teaching object such that, when rendered by a browser module, a predetermined static view of the animation is provided prior to the animated teaching object being initiated, wherein the predetermined static view illustrates the animation immediately after or before the execution of a predetermined one of the animation instructions.

In another aspect of the disclosure, the processor is configured to instruct the user interface to display a third input object for receiving one or more inputs from the user to initiate a previewing of the animation in a preview animation pane. In another aspect, the processor is configured to instruct the user interface to display a third input object for receiving a plurality of inputs from the user to initiate a previewing of a plurality of scenes of the animation in a preview animation pane, respectively.

Another aspect of the disclosure relates to an apparatus for creating or modifying a source file comprising codes for instructing an authoring module as to how to create browser-renderable teaching objects including a browser-renderable animated teaching object configured to generate an animation. The apparatus comprises a user interface; and a processor configured to: (1) instruct the user interface to display a first input object configured to receive the codes from a user, the codes are configured to create one or more animation objects and one or more animation instructions for the one or more animation objects pursuant to the animation; (2) instruct the user interface to display an animation preview pane for illustrating the animation based on the codes; (3) instruct the user interface to display an input object for receiving one or more modifications to the animation; (4) (4) modify the codes based on the one or more modifications, wherein the modified codes are used to create or modify the source file.

In another aspect, the one or more modifications comprises one or more of the following: (1) a modification of at least one attribute of the one or more animation objects; (2) a modification of at least one attribute of the one or more animation instructions; (3) a deletion of at least one of the one or more animation objects; (4) a deletion of at least one or more of the animation instructions; (5) an addition of at least one or more animation objects; and (6) an addition of at least one or more animation objects.

Other aspects, advantages and novel features of the disclosure will become apparent from the following detailed description of the invention when considered in conjunction with the accompanying drawings and appendices.

### BRIEF DESCRIPTION OF THE DRAWINGS AND APPENDICES

FIG. 1 illustrates a block diagram of an exemplary system for facilitating teaching, learning, assessment, and educational content contribution in accordance with an aspect of the disclosure.

FIGS. 2A-2B illustrate a diagram of an exemplary browser-renderable textbook data object in accordance with another aspect of the disclosure.

FIG. 3 illustrates a diagram of an exemplary student data object in accordance with another aspect of the disclosure.

FIG. 4 illustrates a diagram of an exemplary instructor data object in accordance with another aspect of the disclosure.

FIG. 5A illustrates a block diagram of an exemplary system for creating a database of browser-renderable teaching objects for use in one or more browser-renderable textbook data objects in accordance with another aspect of the disclosure.

FIG. 5B illustrates a diagram of an exemplary textbook source file editing module in accordance with another aspect of the disclosure.

FIG. 5C illustrates a screen shot of an exemplary question set authoring module for creating a question set teaching object in accordance with another aspect of the disclosure.

FIG. 6 illustrates a diagram of an exemplary animation authoring module for creating animated teaching objects in accordance with another aspect of the disclosure.

FIG. 7 illustrates a diagram of an exemplary animated teaching object in accordance with another aspect of the disclosure.

FIG. 8 illustrates a diagram of another exemplary animated teaching object in accordance with another aspect of the disclosure.

FIG. 9 illustrates a block diagram of an exemplary server in accordance with another aspect of the disclosure.

FIG. 10 illustrates a block diagram of an exemplary user device in accordance with another aspect of the disclosure.

APPENDICES 1A-1C illustrate exemplary webpages for a Welcome page, Table of Content (TOC), and Chapter 1 of an exemplary textbook data object in accordance with another aspect of the disclosure.

APPENDIX 2 illustrates an exemplary glossary of codes for facilitating the authoring of a textbook data object in accordance with another aspect of the disclosure.

APPENDIX 3 illustrates a tutorial of the exemplary animation authoring module in accordance with another aspect of the disclosure.

APPENDIX 4 illustrates an exemplary glossary of codes for facilitating the authoring of an animated teaching object in accordance with another aspect of the disclosure.

### DETAILED DESCRIPTION OF THE EXEMPLARY EMBODIMENTS

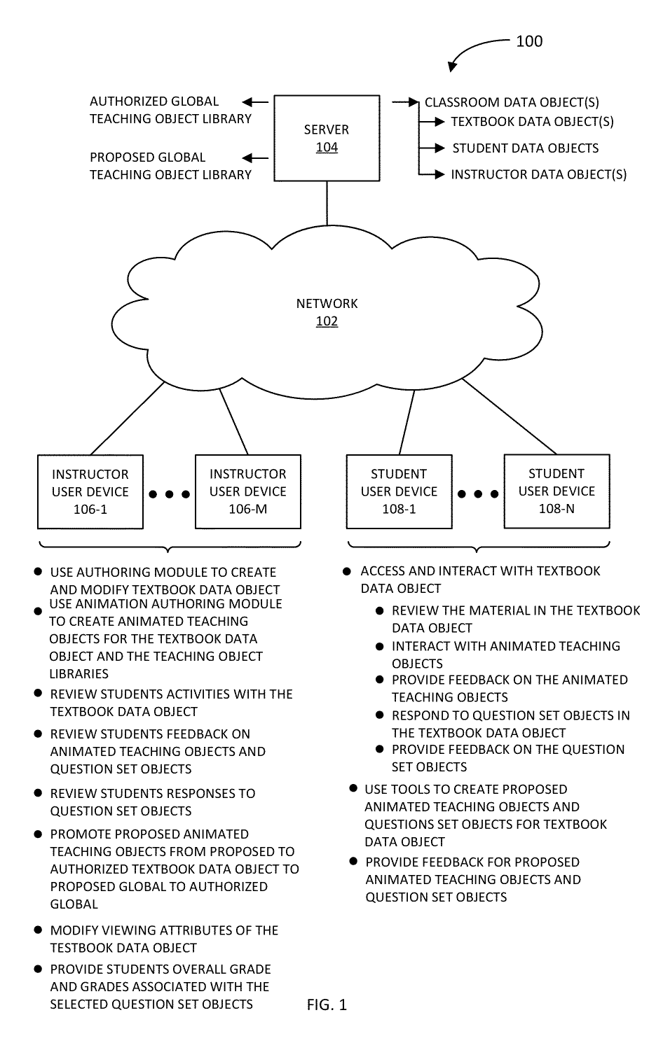

FIG. 1 illustrates a block diagram of an exemplary system 100 for facilitating teaching, learning, assessment, and educational content contribution in accordance with an aspect of the disclosure. The system 100 comprises a network 102, a server 104, a plurality of user devices for instructors 106-1 to 106-M (and/or other personnel from an educational institution), and a plurality of user devices for students 108-1 to 108-N.

The network 102, which may be a wide area network (WAN), such as the Internet, a cellular telephone network, a local area network (LAN), any combination of the aforementioned networks, or some other type of network, communicatively couples the server 104 with the instructor user devices 106-1 to 106-M and with the student user devices 108-1 to 108-N. The server 104 is commonly a virtual machine running on a physical machine along with other virtual machines. The server 104 may be located at the education institution, or more commonly, may be located anywhere in the cloud. The server 104 may also be replicated for any of various reasons such as for responsiveness or fault tolerance.

The instructor user devices 106-1 to 106-M and student user devices 108-1 to 108-N may be any device that is capable of communicating with the server 104 via the network 102, which may include desktop computers, laptop computers, tablet computers, mobile phones, and others.

Using one of the instructor user devices 106-1 to 106-M, an instructor or a personnel of an education institution may send instructions to the server 104 via the network 102 in order to create a classroom data object. The classroom data object may be stored in a database accessible by the server 104. An instructor may use the classroom data object to store and make accessible information related to the class, such as the subject matter being taught in the class, the students that are enrolled in the class, and the one or more instructors (e.g., principal instructor, teacher's assistant, and others) that are involved in teaching the students.

More specifically, the classroom data object comprises one or more browser-renderable textbook data object(s), a plurality of student data objects, and one or more instructor data object(s). As discussed in more detail below, the textbook data object, as well as the other data objects, may be configured as an electronic file, such as a Hypertext Markup Language (HTML) file (e.g., HTML5 compliant file). The textbook data object may be configured similar to a standard textbook. For instance, the textbook data object may include one or more “Introduction” or “Welcome” objects or webpages, one or more table of content (TOC) objects or webpages, and a plurality of chapter and corresponding chapter section objects or webpages. The base content of a textbook data object may come from a publisher or various authors outside the education institution, or may come from instructors or other authors at the education institution itself. That base content may then be extended and improved upon as described subsequently herein.

As exemplified in more detail below, the textbook data object comprises a navigation object for quickly navigating through the textbook data object. For instance, the navigation object may be configured as a side column including hyperlinks for navigating to the welcome object or webpage, TOC object or webpage, and chapters and corresponding chapter section objects or webpages. Additionally, the textbook data object may include a glossary of terms object, wherein each term may be configured as a hyperlink for navigating to locations in the textbook data object that mentions or elaborates on the term. Further, many of the terms in the textbook data object, not necessarily in the glossary or terms object of the textbook data object, may be configured as hyperlinks for navigating to other places in the textbook data object that further mentions or elaborates on the terms.

With regard to teaching objects, the chapter and the corresponding section objects include text objects for providing description of the relevant subject matter, embedded video objects for providing multimedia (visual and/or audio) description of the relevant subject matter, animated teaching objects that visually (and perhaps with accompanying audio) illustrate various concepts of the relevant subject matter, interactive animated teaching objects that involve the student learning through clicking or typing on a simulator, game, or other interactive element, and self-assessment or gradable question set objects (e.g., quizzes, exams, tests, etc.) for providing a non-gradable or gradable assessment of the learning progress of the students. For each of the teaching objects, a feedback input object may be provided to allow students to rate or submit comments about the particular teaching tool. This allows an instructor to assess the teaching effectiveness of the particular teaching object, and to modify it to improve its effectiveness or eliminate it all together if the feedback indicates that the object has relatively little or no teaching benefits.

Additionally, for the purpose of augmenting the pool of teaching object content, the textbook data object includes a section for receiving proposed teaching objects, such as video objects, animated teaching objects including interactive teaching objects, and question set objects, authored by instructors or by the students of the class. Each of the proposed teaching objects may include an associated feedback or rating input data object to receive comments from students or other instructors as to the teaching effectiveness of the object. The textbook data object may also include a dynamic list object for identifying in order the most teaching effectiveness proposed teaching objects based on the information received via the feedback or rating input objects. Based on such a list, an instructor associated with the class may promote any student proposed teaching object as an official teaching tool of the textbook data object.

The ordering of the dynamic list may be influenced or determined by other means. One such means is the performance of students on subsequent assessment items after having used a particular teaching object. Another such means is the duration that students voluntarily spend on the teaching object. Another such means is the particular time during which a student voluntarily chooses to use the teaching object, such as just before an exam.

The textbook data object may also include attributes that restrict or limit the viewing of the content of the textbook data object. For instance, an instructor associated with the class may view the entire content of the textbook data object including the information received via the feedback or rating input data objects, responses to question sets, and the lists that order the most effective teaching tools. An instructor, associated with the class, may change the viewing attribute of any of the teaching object rating lists for student viewing as desired, in order to, for example, provide feedbacks to the students and to acknowledge those students that proposed the best teaching objects. This mechanism encourages submission of and creativity in designing teaching objects.

As alluded to above, the students may have a more limited viewing capability of the textbook data object than the one or more associated instructors. For instance, students may be able to view the entire contents of the welcome, TOC, and chapter/section objects, except for the information submitted by students via the feedback or rating input data objects. Additionally, each of the proposed teaching objects may include a viewing attribute that limits the viewing of the particular teaching object to a random subset of the students. Students not enrolled in the class or other members of the public may not be able to view the content of the textbook data object at all.

The above arrangement may involve multiple educational institutions, wherein proposed teaching objects are submitted by and/or made available to multiple institutions, and dynamic lists include objects from those multiple institutions too. The arrangement may also be hierarchical, wherein the top items in the ordered dynamic lists of particular schools are aggregated into another ordered dynamic list, and selection or rejection of objects is made by persons at that aggregated level. Those persons may be editors at a publisher, or a team of instructors. Other arrangements are possible.

An instructor may be an author of a textbook data object who is not affiliated with any classroom or education institution. The author contributes teaching objects (text, animated teaching objects, question set objects, etc.). The resulting textbook data object commonly forms the base material that other instructors and students then extend and modify as described above. Authors may continue to contribute to the textbook data object throughout the lifetime of the object as the object is revised, adding new teaching objects, revising objects, approving objects, etc.

Each student data object includes information related to the particular student. For instance, a student data object may have a section identifying the student (e.g., name, student identification number, address, telephone number(s), email address(es), etc.). Additionally, the student data object may record the interactions of the student with the textbook data object. For instance, if the student plays an embedded video object, that activity is recorded in the student data object. If a student accesses an animated teaching object, that activity is also recorded in the student data object. If a student responds to a question set object, the responses are recorded in the student data object. Further, the student data object also records the identification and status of one or more teaching objects proposed by the students for the textbook data object. In addition, the student data object includes grading information and comments from the one or more instructors associated with the class.

Each instructor data object includes information related to the particular instructor. For instance, an instructor data object may have a section identifying the instructor (e.g., name, employee number, address, telephone number(s), email address(es), etc.). Additionally, the instructor data object may include a section identifying the various classrooms to which the instructor provides teaching assistance. Further, the instructor data object includes permission attributes for modifying the one or more associated textbook data object of the corresponding classroom data object. Also, the instructor data object includes permissions for the instructor to promote proposed animated teaching objects and proposed question set objects from students to: (1) authorized teaching objects in the textbook data object; (2) proposed teaching object in a proposed global teaching object library accessible by other faculty of the educational institution for evaluation purpose; and (3) authorized global teaching object library accessible by faculty of the education institution for authorized use in textbook data objects. The instructor data object may include other items, such as the configuration of the means for ordering the dynamic list of teaching objects, visibility of such object outside the educational institution, allowance of teaching objects from other institutions to be viewed by students at the local educational institution, etc.

With reference again to FIG. 1, one or more instructors, who may be associated with a classroom data object or who more generally may be authors without necessarily having affiliation with a particular classroom data object, may use the one or more instructor user devices 106-1 to 106-M to create a textbook data object with an authoring module described further herein (e.g., adding text, embedded video, animated teaching objects including interactive teaching objects, question set objects, etc.), and store the textbook data object at the server 104. Also, one or more of the instructors may use the one or more user devices 106-1 to 106-M to access at least a portion of the source file for the textbook data object from the server 104 via the network 102, modify the textbook data object with the authoring module, and store the modified textbook data object at the server 104 via the network 102. Additionally, one or more of the instructors may use the one or more instructor user devices 106-1 to 106-M to create teaching objects and upload them to the proposed teaching object library and authorized teaching object library, using modules such as the authoring module, a question set authoring module, and/or an animation authoring module, as described further herein.

With regard to viewing privileges, the one or more instructors, associated with a classroom data object, may use the one or more instructor user devices 106-1 to 106-M to access the browser-rendable textbook data object from the server 104 via the network 102, and view activities of the students with respect to the textbook data object. Further, one or more of the instructors may use the one or more instructor user devices 106-1 to 106-M to access the textbook data object via the network 102 and view students feedback regarding animated teaching objects and question set objects, and other feedback associated with the textbook data object. Additionally, one or more of the instructors may use the one or more instructor user devices 106-1 to 106-M to access the textbook data object via the network 102 and view students' responses to question sets, exams, tests, and other learning assessment objects of the textbook data object.

Further, the one or more instructors, associated with a classroom data object, may use the one or more instructor user devices 106-1 to 106-M to access and modify the source file for a textbook data object to promote any of the teaching objects proposed by students to official or authorized teaching objects of the textbook data object based on feedback and rating information associated with the teaching objects. Also, the one or more instructors may use the one or more instructor user devices 106-1 to 106-M to access one or more authorized teaching objects of the textbook data object, and promote them to the proposed global teaching tool library. The teaching objects in the proposed global teaching object library may be accessible by other faculty members of the associated educational institution for evaluation. Similarly, faculty members of the associated educational institution, using the one or more instructor user devices 106-1 to 106-M, may vote by committee or other mechanisms to promote teaching objects from the proposed global teaching object library to the authorized teaching object library. The teaching objects in the authorized global teaching object library may be freely accessed by faculty for use in any textbook data object. As noted earlier, such arrangement may involve multiple educational institutions, and/or may be hierarchical and may involve a publisher or faculty committees.

The one or more instructors, associated with a classroom data object, may use the one or more instructor user devices 106-1 to 106-M to access student data objects from the server 104 via the network 102 to ascertain responses to gradable question sets, exams, text, and other learning assessment objects, and modify the student data objects to provide grades, comments, and other information indicative of an assessment of the learning progress of the students. Although various operations may be performed using the instructor user devices 106-1 to 106-M as discussed above, it shall be understood that such devices may be used to create other data objects for classroom data objects in furtherance of improved teaching and learning experiences.

With regard to the students associated with a classroom data object, one or more students using the one or more student user devices 108-1 to 108-N may access the textbook data object from the server 104 via the network 102, and interact with the textbook data object for learning the relevant subject matter of the class. For instance, the one or more students may use the one or more student user devices 108-1 to 108-N to review and interact with teaching objects of the textbook data object, such as read text description, view embedded video, view animated teaching objects, interact with interactive animated teaching objects, provide comments via feedback input objects associated with the animated teaching objects, respond to question set objects, provide comments via feedback input objects associated with the question set objects, and provide comments via feedback input objects associated with sections and chapters.

Additionally, the one or more students may use the one or more student user devices 108-1 to 108-N to create proposed teaching objects using the same textbook authoring module, animation authoring module, question set authoring module, and other modules that instructors use. Using the one or more student user devices 108-1 to 108-N, the one or more students may create and store proposed teaching objects at the server 104 via the network 102 for evaluation by the one or more associated instructors and for solicitation of comments from other students of the class. Similarly, using the one or more student user devices 108-1 to 108-N, the one or more students may create proposed question set objects using the authoring module, and store those proposed question set objects at the server 104 via the network 102 for evaluation by the one or more associated instructors and for solicitation of comments from other students of the class. Although various operations may be performed using the student user devices 108-1 to 108-M as discussed above, it shall be understood that such devices may be used to interact with the textbook data object in different manners in furtherance of the students' learning experience.

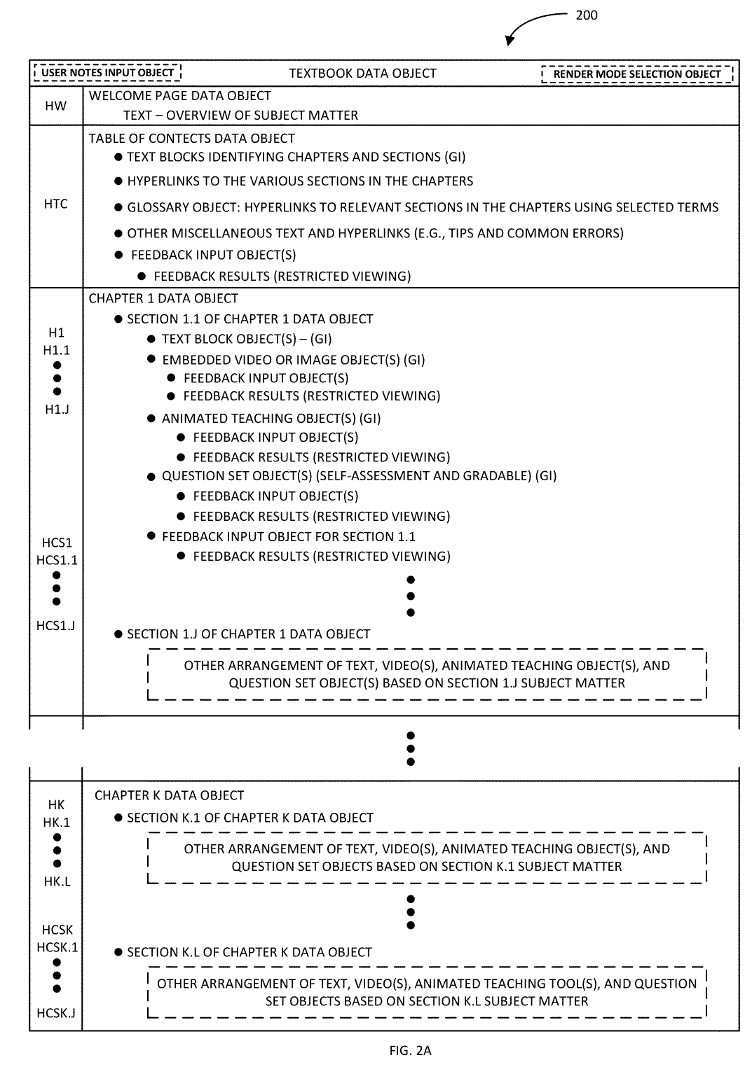

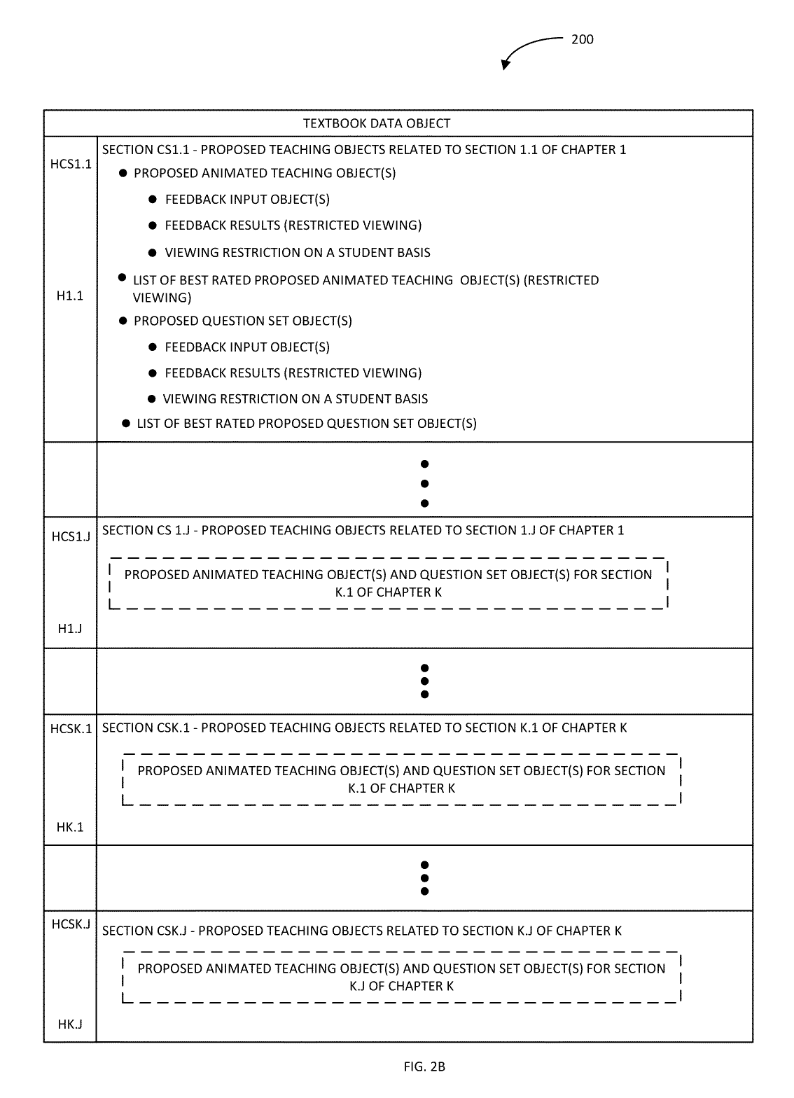

FIGS. 2A-2B illustrate a diagram of an exemplary browser-rendable textbook data object 200 in accordance with another aspect of the disclosure. The textbook data object 200 was previously discussed and summarized. As illustrated, the textbook data object 200 comprises hyperlinks in a navigation object for navigating within the textbook data object. For instance, the leftmost column (i.e., the navigation object) comprises a plurality of hyperlinks HW, HTC, and H1 to HK for quickly navigating to the beginning of the welcome object or webpage, table of contents object or webpage, and chapter objects 1 to K, respectively. An example of a textbook data object is shown in Appendix 1A, where the leftmost column (i.e., navigation object) includes hyperlinks “WELCOME,” “TABLE OF CONTENTS,” “CHAPTER 1 INTRODUCTION,” and so on, for navigating to the beginning of the Welcome object, the Table of Contents object, chapter 1 object, and so on, respectively.

Additionally, portions of the side column (i.e., navigation object) associated with respective chapter objects include hyperlinks for navigating to the beginning of the various section objects of the corresponding chapter objects. For instance, in the side column associated with chapter 1, there are hyperlinks H1.1 to H1.J for navigating to the beginning of section objects 1.1 to 1.J of chapter object 1, respectively. Similarly, in the side column associated with chapter object K, there are hyperlinks HK.1 to HK.L for navigating to the beginning of section objects K.1 to K.L of chapter object K, respectively. An example of a textbook data object is shown in Appendix 1C, where the leftmost column associated with chapter object 1 includes hyperlinks “1.1 Computers and Programs,” “1.2 Computer tour,” “1.3 Language history,” and so on, for navigating to the beginning of section objects 1.1 Computers and Programs, 1.2 Computer tour, 1.3 Language history, and so on, respectively.

Further, the portions of the side column (i.e., navigation object) associated with chapter objects may include hyperlinks to section objects containing proposed animated teaching objects and question set objects related to the corresponding section objects. For instance, in the side column associated with chapter object 1, there are hyperlinks HCS1.1 to HCS1.J for navigating to the beginning of sections CS1.1 to CS1.J (See e.g., FIG. 2B) containing proposed teaching objects related to section objects 1.1 to 1.J of chapter 1, respectively. The CS stands for “crowd sourcing,” i.e., the sourcing of content from the crowd, such as students and instructors. Similarly, in the side column associated with chapter object K, there are hyperlinks HCSK.1 to HCSK.J for navigating to the beginning of section objects CSK.1 to CSK.J (See e.g., FIG. 2B) containing proposed teaching objects related to section objects K.1 to K.J of chapter K, respectively.

With regard to the content of the textbook data object, the “Welcome” object may include text or text object providing an overview description of the relevant subject matter of the textbook data object. For example, Appendix 1A illustrates an example of a Welcome page data object related to a textbook data object for teaching C++ programming. Although in this example, the Welcome page data object only includes text, it shall be understood that it may include one or more pictures, videos, animated teaching objects, interactive teaching objects, question set objects, and other objects.

The Table of Contents data object may include text identifying the chapter objects of the textbook data object. Each part of the Table of Contents pertaining to a chapter object may include hyperlinks to the beginning of the various section objects in the chapter object. Additionally, each part of the Table of Contents pertaining to a chapter includes a glossary or terms section identifying pertinent terms related to the subject matter pertaining to the chapter. The identified terms in the terms section may be hyperlinks for navigating to locations within the chapter object that meaningfully uses the terms. Further, each part of the Table of Contents pertaining to a chapter may include other miscellaneous sections, such as a “Good Practice” section that provides one or more tips related to the relevant subject matter of the chapter. The miscellaneous sections may also include a “Common error” section listing various errors that are commonly done by students.

An example of a Table of Contents (TOC) data object is provided in Appendix 1B. With reference to the section pertaining to Chapter 1 of the Table of Contents, the TOC data object includes text identifying chapter 1, “Chapter 1: Introduction to Computing.” Below that, the TOC data object includes hyperlinks to the various section objects of chapter object 1, such as “1.1 Computers and programs,” “1.2 A brief tour of a computer,” “1.3 Language history,” and so on. Below that, the TOC data object includes the “—Terms” section, listing terms, such as app, application, ASCII art, and so on, relevant to the subject matter of chapter object 1. As previously discussed, the terms also function as hyperlinks for navigating to locations within chapter object 1 that meaningfully uses the terms.

The TOC data object includes a “—Good practice” object providing a tip, “To avoid a long list of compiler error message . . . ” relevant to the subject matter of chapter object 1. One or more terms in the “—Good practice” section may be hyperlinks, such as the underlined “good practice,” for navigating to locations in the chapter object that better explain the tip or tips provided in the “—Good practice” section. The TOC data object includes a “—Common error” object that lists several errors commonly made by students, such as “Forgetting to end each statement with a semicolon . . . ” and others as shown. Similar to the “—Good practice” object, one or more terms in the “—Common error” object may be hyperlinks, such as the underlined “common error,” for navigating to locations in the chapter object that better explain the common error or errors provided in the “—Common error” object. The other objects in the TOC data object pertaining to chapter objects 2-9 may be similarly structured, as shown in Appendix 1B.

The chapter data objects within the textbook data objects provide the bulk description of the subject matter of the textbook data object. As previously discussed, each chapter data object may include a plurality of section data objects. For example, chapter object 1 includes section data objects for sections 1.1 to 1.J, and chapter object K includes section data objects for sections K.1 to K.L. Each section data object may include various objects for teaching the relevant subject matter. Such teaching objects include text for describing the relevant subject matter; embedded video object(s) for allowing students to view videos of the relevant subject matter (e.g., a lecture by an instructor regarding the relevant subject matter); animated teaching object(s), interactive teaching object(s), question set object(s), and a feedback input object for allowing students to submit comments regarding the corresponding section.

For each teaching object, a feedback input object is included to allow students to provide comments or rate the effectiveness of the particular animated teaching object. As indicated, the responses submitted by the students are stored in the textbook data object and may be viewable only by the one or more instructors associated with the textbook data object, and other authorized personnel based on a viewing permissibility parameter. Students may not be able to view such feedback responses when accessing the textbook data object as determined by the associated viewing permissibility parameter.

Similarly, each of the question set objects, either of the self-assessment type or gradable type, may include an associated feedback input object to allow students to provide comments or rate the effectiveness of the particular question set object. Again, such responses submitted by the students are stored in the textbook data object and may be viewable only by the one or more instructors associated with the textbook data object, and other authorized personnel based on a viewing permissibility parameter. Students may not be able to view such feedback responses when accessing the textbook data object as determined by the associated viewing permissibility parameter.

In a like manner, the responses to the section feedback input objects submitted by the students are also stored in the textbook data object and may be viewable only by the one or more instructors associated with the textbook data object, and other authorized personnel based on a viewing permissibility parameter. Students may not be able to view such feedback responses when accessing the textbook data object as determined by the associated viewing permissibility parameter.

An exemplary section data object of a chapter is provided in Appendix 1C. In particular, section object 1.1 Computers and programs of chapter 1 of the Programming in C++ textbook data object is illustrated. As shown, text is provided throughout the section to provide description related to the section subject matter of computers and programs. A picture object (e.g., Figure 1.1.2) is also provided relevant to computers and programs. Various animated teaching objects are provided, such as “Animation 1.1.1: Computer processor and memory,” “Animation 1.1.2: Memory stores instructions and data as 0s and 1s,” and others. Additionally, section 1.1 provides a question set object, “Question set 1.1.1 Computer basics.” As noted, for each animated teaching object and question set object, a feedback input object is provided to receive comments from students. Other objects, such as “Table 1.1.1: Sample processor instructions” may be provided in a section of a chapter.

With particular reference to FIG. 2B, the textbook data object includes crowd sourcing section objects CS1.1 to CS1.J to CSK.1 to CSK.J for including animated teaching objects and question set objects proposed by students that are relevant to the corresponding sections 1.1 to 1.J to K.1 to K.J of the textbook data object. For instance, with further reference to section object CS1.1, each proposed teaching object includes a feedback input object to receive comments or a rating regarding the corresponding proposed teaching object. The results of such comments or rating may be stored in the textbook data object, and may be viewable only by one or more instructors associated with the textbook data object and other authorized personnel based on a viewing permissibility parameter. Additionally, for each proposed teaching object, a viewing permissibility parameter is provided that specifies which students may view the corresponding proposed teaching object. The viewing permissibility parameter may be configured to only allow a subset of the students of the class to view that particular animated teaching object.

An ordered list of the best or most effective proposed teaching objects based on the comments or ratings received via the feedback input objects pertaining to a section may be stored in the textbook data object. An authorized instructor may initially set the viewing permissibility parameter for the list as instructors only. For example, this may be done to maintain the list secret while students continue to submit proposed teaching tools. At a selected time, an instructor may change the viewing permissibility parameter for the list to allow students to view the list for recognition of those that submitted the most effective teaching tools. Based on that list, an authorized instructor may promote one or more of the best proposed teaching tools as authorized teaching objects for the textbook data object.

Similarly, each proposed question set object includes a feedback input object to receive comments or ratings regarding the corresponding proposed question set object. The results of such comments or ratings may be stored in the textbook data object, and may be viewable only by one or more instructors associated with the textbook data object and other authorized personnel based on a viewing permissibility parameter. Additionally, for each proposed question set, a viewing permissibility parameter is provided that specifies which students may view the corresponding proposed question set object. The viewing permissibility parameter may be configured to only allow a subset of the students of the class to view that particular question set object.

Similarly, an ordered list of the best or most effective proposed question set objects based on the comments or ratings received via the feedback input objects pertaining to a section object may be stored in the textbook data object. An authorized instructor may initially set the viewing permissibility parameter for the list as instructors only. For example, this may be done to maintain the list secret while students continue to submit proposed question sets. At a selected time, an instructor may change the viewing permissibility parameter for the list to allow students to view the list for recognition of those that submitted the most effective question set objects. Based on that list, an authorized instructor may promote one or more of the best proposed question sets as authorized teaching tools for the textbook data object.

Each of the teaching objects (e.g., text block, video or image, animation, question set) of the textbook data object 200 has an associated global identifier (GI). Each teaching object may not only be used in the textbook data object 200, but may also be used in other textbook data objects. The global identifier (GI) allows a user to access a teaching object by its global identifier (GI) to edit or update the teaching object. The edits or updates to the teaching objects propagate to all textbook data objects, such as textbook data object 200, that instantiates the teaching object with the same global identifier (GI). This facilitates the editing or updating of a plurality of textbook data objects that incorporate teaching objects with the same global identifiers (GI).

The textbook data object 200 may further include a rendering mode selection input object. Based on a selection made by the user or a preconfigured setting, the rendering mode selection controls the visual rendering of the textbook data object 200 when accessed by a user. A user may set the rendering mode (RM) in accordance with a desired use of the textbook data object 200. As examples, there may be four (4) rendering modes (other rendering modes are possible):

(1) A “Learner's” (or normal) rendering mode allows for the viewing of all of the teaching objects (texts (including equations), video, animation, question sets) by a user accessing the textbook data object 200.

(2) A “Presentation” rendering mode may be applicable when a user (e.g., an teacher or instructor) is using the textbook data object 200 in a classroom or lecture environment. In such Presentation rendering mode, selected content (texts (including equations), video, animation, question sets) are not viewable when the textbook data object 200 is accessed as determined by the associated rendering mode attribute (i.e., an abbreviated version of the textbook data object is rendered). Alternatively, or in addition to, in the Presentation rendering mode, the textbook data object 200 may only display bullet points associated with the teaching object. In one implementation, the Presentation rendering mode is applied to teaching object types in a preselectable manner (e.g., hide all question sets, animation, etc.). In another implementation, the Presentation rendering mode allows the user to set the rendering mode for each teaching object.

(3) A “Summary” rendering mode may be available to users to customize the rendering of the textbook data object 200 as desired. In Summary mode, a user may control what is viewable in order to view the textbook data object 200 in a desired manner—e.g., to hide content that is not of a particular interest to the user. Similar to the Presentation rendering mode, the “Summary” mode may be applied to teaching object types in a preselectable manner (e.g., hide all question sets, animation tools, etc.), or in a manner that allows a user to set the rendering mode for each teaching object.

(4) A “Compact” rendering mode allows a user to control the rendering of the textbook data object 200 such that only the captions for the teaching objects are shown. Additionally, in Compact rendering mode, the caption may be clickable or selectable by the user in order to expand or completely render the selected object. For example, in Compact rendering mode, an animation object “Animation 1.1.1: Computer processor and memory” as depicted in Appendix 1C may only be shown by its caption (i.e., Animation 1.1.1: Computer processor and memory), whereby the animation is hidden. In Compact rendering mode, the caption, Animation 1.1.1: Computer processor and memory, is clickable or selectable, allowing the user to toggle between showing the animation or hiding the animation.

Other rendering modes may be tailored for visually-impaired users. For instance, in such rendering mode, a browser module may render the textbook data object as an audio output to allow visually-impaired users to interact with the various teaching objects in an audio format or in a manner that the visually-impaired user are capable of understanding the concepts being taught by the various teaching objects.

Additionally, the browser-renderable textbook data object 200 may include one or more user notes input object to receive notes from a user. The browser module may receive such notes and send them to the server 104 for modifying the textbook data object based on the notes. This allows users accessing the textbook data object to view notes regarding the textbook data object submitted by other users.

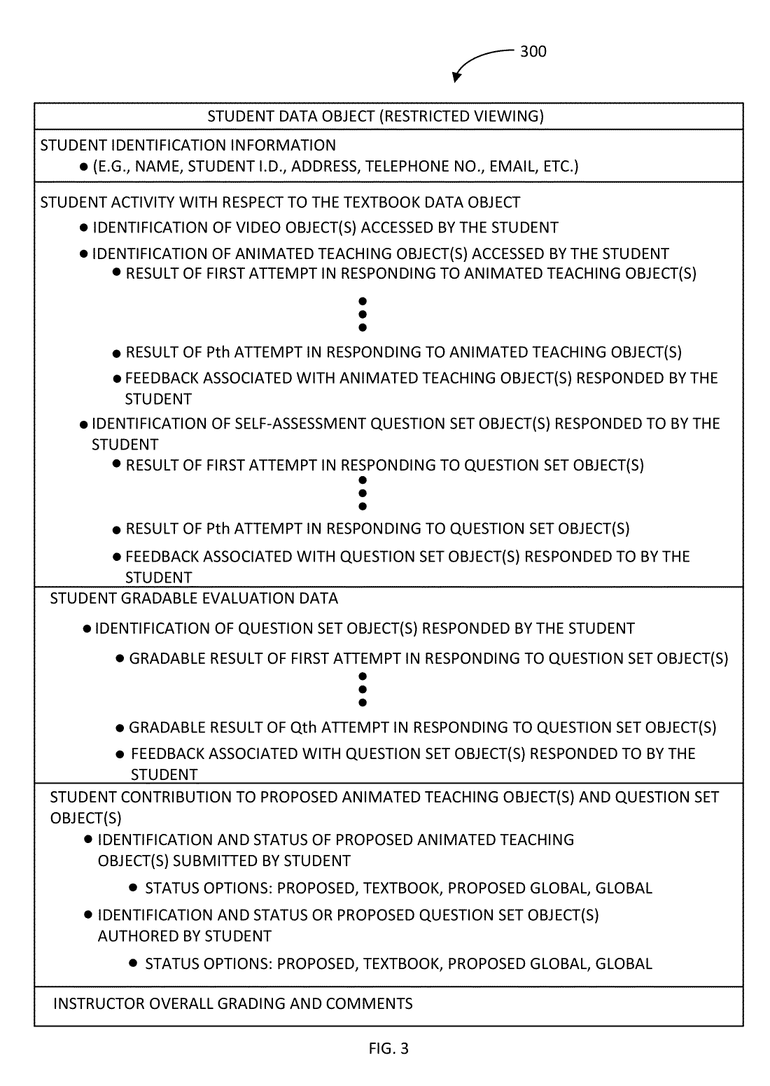

FIG. 3 illustrates a diagram of an exemplary student data object 300 in accordance with another aspect of the disclosure. The student data object 300 may be subject to a viewing permissibility parameter that restricts viewing to only authorized instructors and other authorized personnel of the associated educational institution. Viewing of student data objects by students may be forbidden in accordance with the viewing permissibility parameter. As illustrated, the student data object 300 may include a section identifying the student. Such section may include the student's name, student identification number, address, telephone number(s), email address(es), and other information concerning the student.

The student data object may include a section for tracking the student's activity with regard to the textbook data object. For instance, the section may include an identification of the video object(s) accessed by the student. Additionally, the section may include an identification of animated teaching object(s) accessed and/or responded to by the student, the results of the first to the Pth attempts in responding to the animated teaching objects if the object(s) solicit responses, and any feedback submitted by the student regarding the accessed animated teaching object(s). The section may also include an identification of self-assessment question set object(s) responded to by the student, the results of the first to the Pth attempts in responding to the question set object(s), and feedback submitted by the student regarding the accessed question set object(s). The self-assessment question set object(s) may not affect the overall grade assigned to the student.

The student data object 300 may further include a section for evaluating and grading students. The section may also include an identification of gradable question set object(s) (exams, tests, etc.) responded to by the student, as well as the gradable results of the first to the Qth attempts in responding to the question set object(s), and feedback submitted by the student regarding the accessed question set object(s). Besides gradability, another difference between a self-assessment question set and a gradable question set is the number of attempts allowed in responding to the question set. For instance, a self-assessment question set may allow an unlimited number of attempts by the student in responding to the question set. Whereas, a gradable question set may have an instructor specified limit in the number of attempts by the student in responding to the question set. An instructor may set or modify the textbook data object to specify the number of allowed attempts for responding to a particular gradable question set.

The student data object 300 further includes a section related to the student's contribution to proposed animated teaching object(s) and question set object(s). For instance, the section includes an identification of proposed animated teaching object(s) submitted by the student. For each proposed animated teaching object(s) submitted by the student, a status associated with the proposed object may be provided. For instance, the status may indicate that the submitted animated teaching object is still a proposed object, or an authorized object for a textbook data object, or a proposed object in the global proposed teaching object library, or an authorized object in the global authorized teaching object library.

Similarly, the section includes an identification of proposed question set object(s) submitted by the student. For each proposed question set(s) submitted by the student, a status associated with the proposed question set object may be provided. For instance, the status may indicate that the submitted question set is still a proposed question set, or an authorized question set for the textbook data object, or a proposed question set in the global proposed teaching object library, or an authorized question set in the global authorized teaching object library.

The student data object 300 may further include a section for identifying an overall grade for the student assigned by an instructor, as well as comments related to the student's learning performance by the instructor. It shall be understood that the student data object 300 is merely one example, and may include more, less and/or different information as that discussed above.

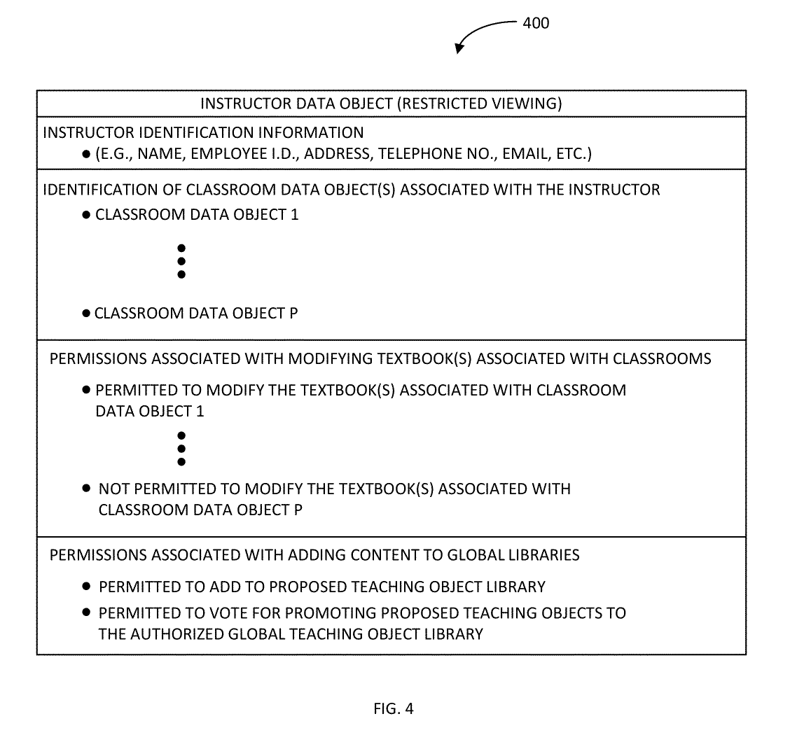

FIG. 4 illustrates a diagram of an exemplary instructor data object 400 in accordance with another aspect of the disclosure. The instructor data object 400 may be subject to a viewing permissibility parameter that restricts viewing to only the instructor and other authorized personnel of the associated educational institution. As illustrated, the instructor data object 400 may include a section identifying the instructor. Such section may include the instructor's name, employee identification number, address, telephone number(s), email address(es), and other information concerning the instructor.

The instructor data object 400 includes a section identifying the classroom data objects associated with the instructor. As it is common, many instructors teach more than one class at an educational institution. In this example, this section of the instructor data object 400 identifies those classroom data objects 1-P, where P can be one or more; whereby P being one indicates that the instructor is associated only with a single classroom.

The instructor data object 400 also includes a section indicating permissions associated with modifying textbook data object(s) associated with the identified classroom data object(s) 1-P. The permission indicates whether the instructor is able to modify the textbook data object(s) associated with the corresponding classroom. For instance, according to this example, the instructor is permitted to modify the textbook data object(s) for classroom data object 1. This may be the case where the instructor is the primary instructor associated with classroom data object 1. Also, according to this example, the instructor is not permitted to modify the textbook data object associated with classroom data object P. Similarly, this may be the case where the instructor is only a teacher's assistant, subordinate instructor, auditing instructor, or other personnel that may have an unrestricted view of the textbook data object, but not necessarily permitted to edit the textbook data object.

The instructor data object 400 also comprises a section indicating permissions associated with the instructor promoting authorized animated teaching object(s) and question set object(s) used in textbook data object(s) to the proposed global teaching tool library. As an example, if an instructor determines that a particular animated teaching object or question set object is highly effective, the instructor may promote the animated teaching object or question set object to the proposed global teaching object library. Other associated faculty members may access animated teaching objects and question set objects from the proposed global teaching tool library for evaluation and trial testing. This section may also specify whether the instructor is able to vote in promoting animated teaching objects and question set objects from the proposed global teaching object library to the authorized global teaching object library. Animated teaching objects and question set objects in the authorized global teaching object library may be accessed by any instructor of the associated education institution for authorized use in textbook data object(s). It shall be understood that the instructor data object 400 is merely one example, and may include more, less and/or different information as that discussed above.

Promotion may occur in other ways. For example, a student whose contributions are consistently well-rated may achieve a status that automatically promotes the student's contributions.

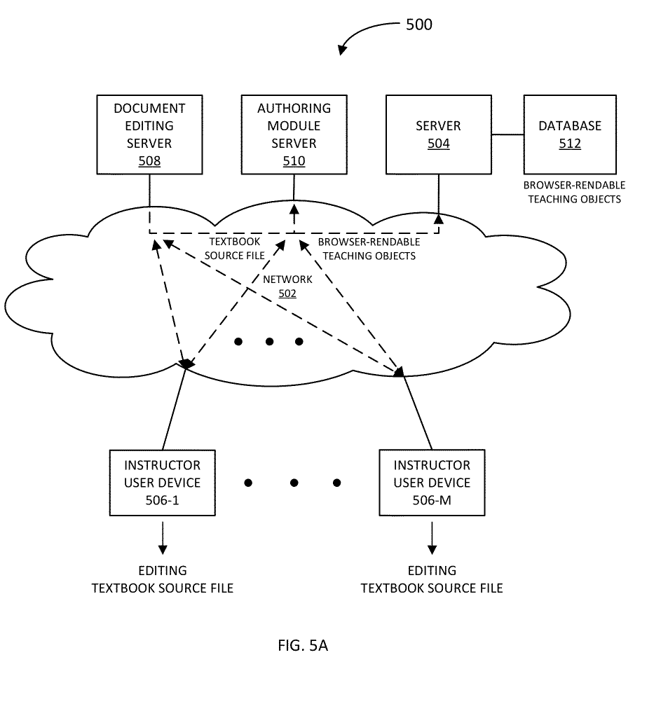

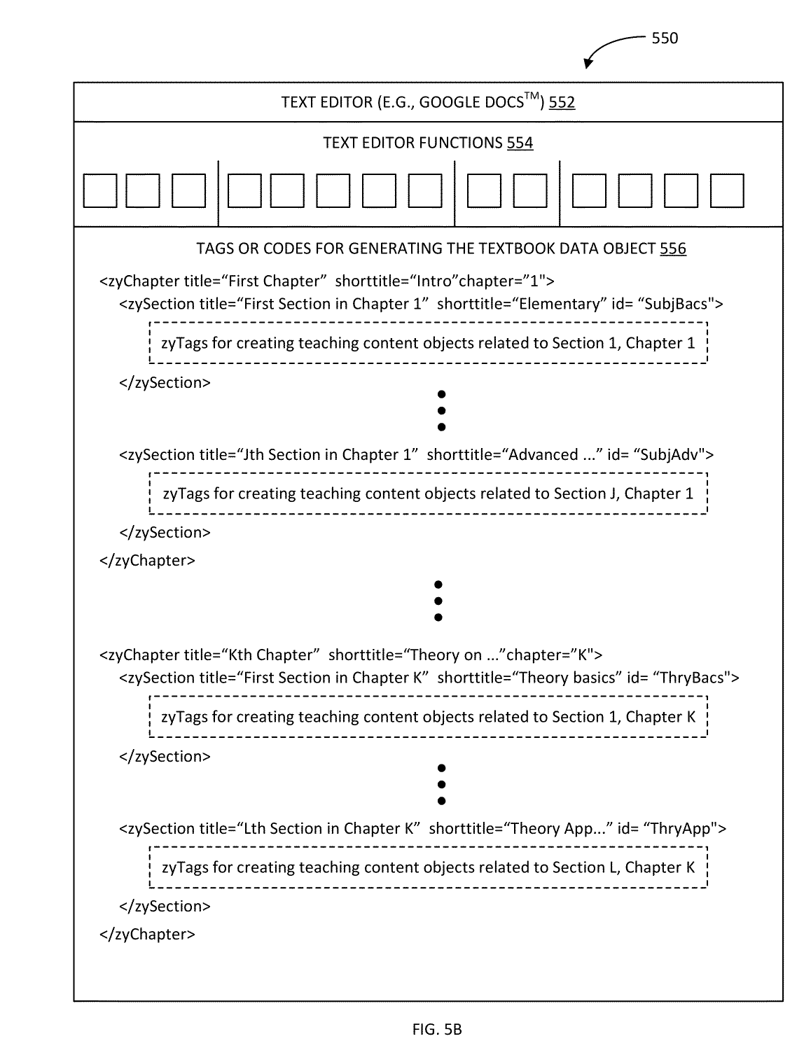

FIG. 5A illustrates a block diagram of an exemplary system 500 for creating a database of teaching objects for use in browser-renderable a textbook data objects in accordance with another aspect of the disclosure. For clarity, a textbook source file includes the codes or tags for instructing an authoring module to generate browser-renderable teaching objects. The browser-renderable teaching objects may be stored in a database, such as a database associated with an education institution. The system 500 is used herein to illustrate how the textbook source file may be created and modified, and how the authoring module creates browser-renderable teaching objects based on the textbook source file.

In particular, the system 500 comprises a network 502, which could be similar to that of network 102 previously discussed. Additionally, the system 500 includes a server 504, which could also be similar to that of server 104 previously discussed. In this example, the server 504 may include an associated database 512 that stores a plurality of browser-renderable teaching objects for textbook data objects. A particular textbook data object may be created by referencing the desired browser-renderable teaching objects stored in the database 512. Although, in this example, the database 512 is part of or connected directly to the educational institutional server, it shall be understood that the database 512 may be directly coupled to the network 502 and accessible directly via the network 502 or directly coupled to another server which, in turn, is coupled to the network 502.

The system 500 further comprises a plurality of instructor user devices 506-1 to 506-M, which could be similar to instructor user devices 106-1 to 106-M, previously discussed. Additionally, for facilitating the simultaneous editing of the textbook source file by the instructors using the instructor user devices 506-1 to 506-M, the system 500 comprises a document editing server 508. As an example, the document editing server 508 may be a GOOGLE DOCS™ server that supports the simultaneous editing of documents, version control, author-specific color codes for identifying edits made by specific authors, and other features that may be useful in creating and editing textbook source files.

Further, the system 500 comprises an authoring module server 510 for generating teaching objects based on textbook source files created by the document editing server 508 via codes or tags received from user devices 506-1 to 506-M. More specifically, one or more users, using the one or more user devices 506-1 to 506-M, create a textbook source file (e.g., a plain text file) of tags or codes (e.g., XML-compliant tags and HTML) via the document editing function provided by the document editing server 508. The one or more users, using the one or more user devices 506-1 to 506-M, access the authoring module provided by the authoring module server 510, and provide the textbook source file as an input to the authoring module.

The authoring module provided by the authoring module server 510 then generates browser-renderable teaching objects based on the tags or codes of the textbook source file. For example, the textbook source file may include tags or codes for creating a textbook section object, which, in turn, comprises a plurality of teaching objects. Such teaching objects include animated teaching objects, question set teaching objects, video/image/drawing teaching objects, table/graphs teaching objects, text-based teaching objects, as explained in more detail herein. Each teaching object may comprise a plurality of browser-rendering codes and scripts, such as HTML codes, XML-compliant codes, and JavaScript Object Notation (JSON) codes. In some cases, the authoring module merely passes the HTML and XML-compliant codes to generate the corresponding teaching object, such as in the case of text-based teaching objects and animated teaching objects. In other cases, the authoring module parses out the codes and adds JSON script codes to generate the corresponding teaching object, such as in the case of a question set teaching object.

The one or more users, using the user devices 506-1 to 506-M, instructs the authoring module provided by the server 510 to save the created teaching objects into a database, such as database 512. In other words, the one or more users informs the authoring module where to save the created teaching objects. Thus, the database 512 contains a plurality of teaching objects that may be assembled by users to create a desired browser-renderable textbook data object. The textbook data object may be accessed by viewing users, such as students, using a browser module operating on a user device; the browser module renders the textbook data object on a display (or speaker for visually-impaired users) associated with the user device.

As explained below in further detail, the textbook source file may include XML conforming codes, such as Zyante codes (identified with a “zy” prefix), and other codes, such HTML, from which the authoring module generates browser-renderable teaching objects for storage in a user-accessible database for creating browser-renderable textbook data objects.

FIG. 5B illustrates a diagram of an exemplary textbook source file editing module 500 in accordance with another aspect of the disclosure. As previously discussed, the authoring module generates teaching objects based on tags or codes specified in the textbook source file. As previously discussed, the tags or codes may be XML conforming tags, such as special tags (Zyante tags) for facilitating the creation and editing of a textbook source file. The document may further include other tags and scripts, such as HTML, CSS, Javascript as provided by the author in creating the textbook source file. Further, as previously discussed, the textbook source file may be created and/or edited at a server, such as a GOOGLE DOC™ server, which supports simultaneous editing of documents, version control, author-specific color codes for identifying edits made by specific authors, and other features that may be useful in creating and editing textbook source files.

In particular, the textbook source file editing module 500 includes a heading area 552 (e.g., GOOGLE DOC™), an editor function area 554 that includes a plurality of available functions associated with the editor (Open, Save, Save as, Copy, Cut, Paste, View, etc.), and an area 556 for depicting the tags or codes for creating browser-renderable teaching objects for a textbook data object. Although a textbook source file for creating an entire textbook data object is shown, it shall be understood that the source file may include only a portion of an entire textbook, such as a single section including a plurality of teaching objects.

As illustrated, the textbook source file includes codes for instructing the authoring module to create one or more browser-renderable chapter objects. For instance, the opening tag <zyChapter title=“First Chapter” shorttitle=“Intro” chapter=“1”> and the following closing tag </zyChapter> instructs the authoring module to create a browser-renderable chapter object for Chapter 1 of the textbook data object. Similarly, the opening tag <zyChapter title=“Kth Chapter” shorttitle=“Theory on . . . ” chapter=“K”> and the following closing tag </zyChapter> instructs the authoring module to create a browser-renderable chapter object for Chapter K of the textbook data object. A chapter object identifies a plurality of section objects, as discussed below.

Also, as illustrated, the textbook source file includes codes for instructing the authoring module to create one or more browser-renderable section objects within each chapter object. For instance, the opening tag <zySection title=“First Section in Chapter 1” shorttitle=“Elementary” id=“SubjBacs”> and the following closing tag </zySection> instructs the authoring module to create a section object for Section 1 of Chapter 1 of the textbook data object. Similarly, the opening tag <zySection title=“Jth Section in Chapter 1” shorttitle=“Advanced” id=“SubjAdv”> and the following closing tag </zySection> instructs the authoring module to create a section object for Section J of Chapter 1 of the textbook data object.

Similarly, the opening tag <zySection title=“First Section in Chapter K” shorttitle=“Theory basics” id=“ThryBacs”> and the following closing tag </zySection> instructs the authoring module to create a section object for Section 1 of Chapter K of the textbook data object. Similarly, the opening tag <zySection title=“Lth Section in Chapter K” shorttitle=“Theory App” id=“ThryApp”> and the following closing tag </zySection> instructs the authoring module to create section object for Section L of Chapter K of the textbook data object. A section object identifies a plurality of teaching objects, as discussed below.

The textbook source file further includes a plurality of tags or codes positioned within opening and closing section tags for instructing the authoring module to create teaching objects associated with the section. As illustrated, there are zyTags for creating teaching objects related to Section 1 of Chapter 1. There are zyTags for creating teaching objects related to Section J of Chapter 1. There are zyTags for creating teaching objects related to Section 1 of Chapter K. And, there are zyTags for creating teaching objects related to Section L of Chapter K.

As previous discussed, in the example of FIG. 5A, the textbook source file is illustrated as creating and/or editing an entire textbook source file, it shall be understood that the textbook source file may be configured to create and edit one or more portions of or one or more teaching objects for one or more textbook source files. In such a case, an author may simply use the appropriate tags or codes to create the desired portion, such as, for example, a section object including a plurality of teaching objects. As previously discussed in connection with a GOOGLE DOC™ environment, a plurality of authors may be able to simultaneously edit the same source file for a textbook data object, whereby GOOGLE DOC™ provides version control to effectuate the simultaneous editing of the same source file.

The following provides a description of the various XML conforming “zy” tags or codes available for creating and editing a textbook source file. As previously discussed, a textbook source file includes codes or tags configured to instruct the authoring module running on the server 510 how to create one or more browser-renderable teaching objects for storing in the database 512.

To begin, there are Zyante tags or codes for instructing an authoring module to create chapter object of a browser-renderable textbook data object. (See e.g., 1.2 zyChapter and zySection of Appendix 2). A chapter object comprises a plurality of section objects. The tags for creating a chapter object may be compliant with XML protocol, which typically includes an opening tag (zyChapter), a closing tag (/zyChapter), and attributes, such as “title”, “shorttitle”, and “chapter.” The attribute title=“[Name of Chapter]” instructs the authoring module to create the chapter object such that, when rendered by a browser module, a title is displayed with a predefined emphasizing visual attribute (e.g., font, color, background, border different than how other text is displayed in textbook data object) at the beginning of the rendered chapter object. The attribute shorttitle=“[Short Name for Chapter]” instructs the authoring module to configure a browser-renderable navigation object and browser-renderable table-of-content object to include respective hyperlinks identified by the “shorttitle”. The hyperlinks allow a user to quickly navigate to the beginning of the rendered chapter object. The attribute chapter=“N” (where “N” is an integer) instructs the authoring module to configure the chapter object such that, when rendered by a browser module, the chapter number is displayed proximate the chapter name at the beginning of the chapter object. This attribute also combines the chapter number N with the “shorttitle” in rendering the hyperlinks in the navigation and table-of-content objects.

As an example, the following tags or codes may be used by the authoring module to create a browser-renderable chapter object for a Chapter 1 entitled “Introduction to Computing” with a short title of “Introduction”:

<zyChapter title=”Introduction to Computing” shorttitle=”Introduction”
chapter=”1”>
...... Section(s) go here .....
</zyChapter>

A browser module may render the aforementioned chapter object as follows:

| Navigation Object | Table of Content Object: |
|---|---|
| 1. Introduction | 1. Introduction |
| | Chapter 1 Object: |
| | Chapter 1: Introduction to Computing |

Tags or codes for section objects and teaching objects pertaining to a chapter object are placed between opening (zyChapter) and closing (/zyChapter) chapter tags or codes. These tags or codes also instruct the authoring module to configure section objects and corresponding hyperlinks in the navigation and table-of-content objects associated with the chapter object based on the chapter number and the order of the section within the chapter object. For example, the fourth section object within the first chapter object may be automatically numbered or identified as 1.4.

Thus, the processor operating the authoring module may be configured to automatically number the chapter objects and section objects based on their order within the textbook data object. Additionally, the processor operating the authoring module may be further configured to renumber the chapter objects and section objects based on organizational changes made to the textbook data object to ensure that chapter objects and section objects are number in accordance to their order within the textbook data object.

Similar to the tags or codes for creating a chapter object, there are Zyante tags or codes for instructing the authoring module to create a browser-renderable section object. (See e.g., 1.2 zyChapter and zySection of Appendix 2). A section object comprises a plurality of teaching objects. The tags for creating a section object may be compliant with XML protocol, which typically includes an opening tag (zySection), a closing tag (/zySection), and attributes, such as “title”, “shorttitle”, “id”, and “suppress.” The attribute title=“[Name of Section]” instructs the authoring module to configure the section object such that, when rendered by a browser module, the specified title is displayed with a predefined emphasizing visual attribute (e.g., font, color, background, border different than how other text is displayed in textbook data object) at the beginning of the corresponding section object. The attribute shorttitle=“[Short Name for Section]” instructs the authoring module to configure the navigation and table-of-content objects to include hyperlinks to the beginning of the section object, the hyperlinks being rendered with the shorttitle name. The attribute id=“[Section identifier]” instructs the authoring module to configure browser-renderable teaching objects within the corresponding section object to include prepended identifiers for generating corresponding global identifiers for the teaching objects, respectively. The attribute suppress=“[Under Construction]” instructs the authoring module is configure the section object such that, when rendered by a browser module, the teaching object(s) pertaining the section object are not rendered, and instead the description specified by the suppress attribute is rendered, such as “Under Construction.”

As an example, the following tags or codes instruct an authoring module to create a browser-renderable section object pertaining to a first section under chapter “1” with a title of “The basics of Computing,” a short title of “Computing basics,” and an id of “CmpBscs”:

<zySection title= “The basics of computing” shorttitle=“Computing
basics” id= “CmpBscs”>
...... Teaching objects .....
</zySection>

A browser module may render the aforementioned section object as follows:

| Navigation Object: | Table of Content Object: |
|---|---|
| 1.1 Computing basics | 1.1 Computing basics |
| | Section 1.1 Object: |
| | Section 1.1: The basics of computing |

As illustrated above, the aforementioned tags or codes instructs the authoring module to configure browser-renderable navigation and table-of-content objects with hyperlinks identified by the section number and the short title. The rendered hyperlinks, when clicked or selected, instructs a browser module to display or render the beginning of the section object on the display. Tags or codes for subsections and teaching objects pertaining to the section are placed between the opening (zySection) and closing (/zySection) section tags or codes. These tags or codes also instruct the authoring module to configure the navigation and table-of-content objects to include hyperlinks for the subsection based on the section number and the order of the subsection within the section. For example, the third subsection within the second section of chapter 1 may be automatically numbered or identified as 1.2.3. This automatic numbering process applies to subsections within subsections in the same manner as subsections within sections and sections within chapters.

There are Zyante tags for instructing the authoring module to create a browser-renderable: Glossary or Terms object, a Good Practice object, a Common Error object, and a Definitions object. (See e.g., 1.3 zyTerm, zyGoodPractice, zyCommonError, and zyDefn of Appendix 2).

In particular, the zyTerm tag or code instructs the authoring module to create a browser-renderable term teaching object that, when rendered by a browser module, displays the associated term with a defined text or font attribute (e.g., at least bold), and renders a hyperlink in an associated a table of contents and/or glossary object. The hyperlink, when clicked or selected, instructs the browser module to navigate to a section object in which the associated term is referenced. The zyTerm tag or code also include an attribute “obeycase,” which instructs the authoring module to configure the term teaching object to include the associated term with the indicated case (i.e., being case sensitive). The default setting, i.e., the zyTerm tag without the “obeycase” attribute, instructs the authoring module to configure the term teaching object with the associated term being in lower case (i.e., to ignore the case of the specified term). The following example illustrate the use of the zyTerm tag or code to define the case-sensitive term “RAM”:
<zyTerm obeycase=true>RAM</zyTerm>

The zyDefn tag or code instructs the authoring module to create a browser-renderable definition teaching object that, when rendered by a browser module, displays an associated term and term definition with a defined text or font attribute (e.g., at least bold), and renders a hyperlink in a table of content and/or glossary object. The hyperlink, when clicked or selected, instructs the browser module to navigate to a section object in which the associated term and definition are referenced. The associated term is placed within the zyDefn tags by surrounding it by underscores. The zyDefn tag or code also includes the “obeycase” attribute, which instructs the authoring module to configure the definition teaching object such that, when rendered by a browser module, the associated term and definition is displayed in the indicated case (i.e., being case sensitive). The default setting, i.e., the zyDefn tag without the “obeycase” attribute, instructs the authoring module to configure the definition teaching object such that, when rendered by a browser module, the associated term and definition are displayed in lower case (i.e., ignores the case of the associated term and definition). The following example illustrates the use of the zyDefn tag or code to define the case sensitive term “RAM”:
<zyDefn obeycase=true>_RAM_Random Access Memory</zyDefn>

The zyGoodPractice tag or code instructs the authoring module to create a browser-renderable good practice teaching object that, when rendered by a browser module, displays text describing a good practice. The rendered good practice teaching object includes a “—Good practice” subheading with the specified sentence immediately below or proximate to the subheading, and the terms “good practice” in the sentence being automatically underlined. Thus, the sentence should include the terms “good practice.” The zyGoodPractice tag or code includes an attribute “id” used by the authoring module for assigning a global identifier to the good practice teaching object. In particular, the authoring module may generate the global identifier (GI) by prepending of the corresponding section id, the tag type (e.g., GP for good practice), and the tag id. The following example illustrates the use of the zyGoodPractice tag or code for the sentence, “Good practice involves always initializing variables”:
<zyGoodPractice id=“5”> Good practice involves always initializing variables </zyGoodPractice>
   Using the aforementioned tags or codes, a browser module may render the good practice teaching object as follows:

-Good practice
• Good practice involves always initializing variables

Similarly, the zyCommonError tag or code instructs the authoring module to create a browser-renderable common error teaching object that, when rendered by a browser module, displays text identifying a common error. The rendered common error teaching object includes a “—Common error” subheading with the specified sentence immediately below or proximate to the subheading, and terms “common error” in the sentence being automatically underlined. Thus, the sentence should include the terms “common error.” The zyCommonError tag or code includes an attribute “id” used by the authoring module for assigning a global identifier to the common error teaching object. In particular, the authoring module may generate the global identifier (GI) by prepending of the corresponding section id, the tag type (e.g., CE for common error), and the tag id. The following example illustrates the use of the zyCommonError tag or code for the sentence, “A common error is to use “=” when “==” was intended”:
<zyCommonError id=“3”> A common error is to use “=” when “==” was intended </zyCommonError>
   Using the aforementioned tags or codes, a browser module may render the common error teaching object as follows:

-Common Error
• A common error is to use “=” when “==” was intended

There are Zyante tags for instructing the authoring module to create browser-renderable teaching objects that include programming language codes (e.g., C++ programming language codes) for teaching purposes, without having a browser module interpreting those codes as rendering codes (e.g., XML and/or HTML codes). (See e.g., 1.4 zyCode, zyInlineCode and zyConsole of Appendix 2).

In particular, the zyCode tag or code instructs the authoring module to create a browser-renderable teaching object that, when rendered by a browser module, displays programming code for teaching purposes without the browser module (e.g., the HTML parser of the browser) interpreting the programming codes as HTML or rendering codes. The zyCode tag or code has four attributes, “language”, “highlight”, “highlightcolor”, and “nobox”. The “language” attribute informs the authoring module of the programming language associated with the programming code (e.g., “c”, “cpp”, “matlab”, “java”, or “python”). When the “language” attribute is specified, the authoring module configures the rendered teaching object to display the programming code in a predefined color. If the “language” attribute is not specified, the authoring module configures the rendered teaching object to display the code in black. The “highlight” attribute instructs the authoring module to configure the rendered teaching object to highlight programming code in the specified one or more line numbers (e.g., highlight=“1,2” instructs a browser module to highlight the programming codes in lines 1 and 2). The “highlight[color]” attribute (e.g., highlightyellow=“1,3,4”) instructs the authoring module to configure the rendered teaching object to highlight the codes in the specified one or more lines with the specified color (e.g., yellow). The “nobox” attribute, when true, instructs the authoring module to configure the rendered teaching object to remove a default colored box surrounding programming code that the browser module automatically renders in response to zyCode tag.

The zyInlineCode tag or code (now renamed as the zylCode) instructs the authoring module to create a teaching object that, when rendered by a browser module, displays the specified programming codes within a paragraph of text with a defined format. The defined formatting may be a monospaced font. The zylCode includes an “allowwrap” attribute, which when set “true”, instructs the authoring module to configure the teaching object such that, when rendered by a browser module, the programming code is allowed to wrap to the next line of a paragraph. Otherwise (when the “allowwrap” attribute is not specified or is specified as “false”), the rendered programming code is not allowed to wrap to the next line of the paragraph.

The zyConsole tag or code instructs the authoring module to create a teaching object that, when rendered by a browser module, the programming codes are rendered with a defined formatting. Such defined formatting may include preserving white spaces and displaying the code in a monospaced font.

There is a Zyante tag for instructing the authoring tool to create a browser-renderable figure object of a textbook data object. (See e.g., 1.5 zyFigure of Appendix 2). The zyFigure tag or code instructs the authoring module to create a figure object that, when rendered by a browser module, the identified figure is rendered within a labeled box object. The browser module automatically labels the box object with the term “Figure” followed by three numbers separated by dots, the numbers pertaining to the chapter and section in which the figure is situated, and the order of figure within the corresponding section. For example, if the box object is situated within chapter 5, section 3, and corresponds to the second figure in section 3, the browser module automatically labels the box object as “FIG. 5.3.2.” The zyFigure has two attributes, “caption” and “id.” The “caption” attribute instructs the authoring module to configure the figure object such that, when rendered by a browser module, a specified descriptive title is displayed proximate the box label (e.g., Figure 5.3.2: A simple first program). The “id” attribute is used by the authoring module to assign a global identifier (GI) for the figure object. Other zy tags, HTML, images, drawings, video, and other objects may be inserted within opening and closing zyFigure tags for instructing the authoring module to configure the figure object with other associated teaching objects.

There are tags or codes for instructing the authoring tool to create specific browser-renderable teaching objects, such as a zyTry object for providing student a hands on activity to learn concepts, a ZyConstruct object for defining a new programming language construct, zyTable object for automatically numbering tables, a zyEnum object for allowing authors to define his/her own enumerated box type, and a zyExample object for creating or delineating large continuous examples. (See e.g., 1.6 zyTry, 1.7 zyConstruct, 1.8 zyTable, 1.9 zyEnum, and 1.10 zyExample of Appendix 2).

In particular, the zyTry tag or code instructs the authoring module to create a browser-renderable zyTry teaching object that, when rendered by a browser module, displays a box object containing text instructing or suggesting to a user to perform or try a specified task. Similar to the zyFigure tag or code, a rendered zyTry object is labeled based on the corresponding chapter number, section number, and zyTry box object order. For example, a browser module renders a zyTry object as “Try 3.7.1” if the zyTry object is in the third chapter, seventh section, and is the first ztTry object in the seventh section. Similar to the zyFigure tag or code, the zyTry tag or code includes “caption” and “id” attributes. The “caption” attribute instructs the authoring module to configure the zyTry object such that, when rendered by a browser module, a specified descriptive title is provided for the object (e.g., Try 3.7.1: Perform a task). The “id” attribute is used by the authoring module to assign a global identifier (GI) for the zyTry object. HTML tags may be used to instruct the authoring module to configure the zyTry object to include text regarding the try instruction or suggestion.

The zyConstruct tag or code instructs the authoring module to create a zyConstruct teaching object which, when rendered by a browser module, displays a boxed object that indicates a new programming language construct. Similar to the zyFigure tag or code, a browser module renders the zyConstruct object with a label based on the corresponding chapter number, section number, and zyConstruct object order. For example, a browser module renders a zyConstruct object with the label “Construct 3.8.1” if the zyConstruct object is in the third chapter, eighth section, and is the first zyConstruct object in the eighth section. Similar to the zyFigure tag or code, the zyConstruct tag or code includes “caption” and “id” attributes. The “caption” attribute instructs the authoring module to configure the zyConstruct object such that, when rendered by a browser module, a specified descriptive title is provided for the object (e.g., Construct 3.8.1: A new language feature.). The “id” attribute is used by the authoring module to assign a global identifier (GI) for the zyConstruct object. HTML tags may be used to instruct the authoring module to configure the zyConstruct object to include texts regarding the new programming construct in the zyConstruct object.

The zyTable tag or code instructs the authoring module to create a zyTable teaching object that, when rendered by a browser module, displays a boxed object that includes a defined table. Similar to the zyFigure tag or code, a browser module renders a label for zyTable object based on the corresponding chapter number, section number, and zyTable object order. For example, the browser module renders a label for a zyTable object as “Table 3.9.1” if the zyTable object is in the third chapter, ninth section, and is the first zyTable object in the ninth section. Similar to the zyFigure tag or code, the zyTable tag or code includes “caption” and “id” attributes. The “caption” attribute instructs the authoring module to configure the zyTable object such that, when rendered by a browser module, a specified descriptive title is provided for the zyTable (e.g., Table 3.9.1: Simple table.). The “id” attribute is used by the authoring module to assign a global identifier (GI) for the zyTable object. HTML tags may be used to instruct the authoring module to configure the zyTable object with a defined table.

The zyEnum tag or code instructs the authoring module to create a zyEnum teaching object that, when rendered by a browser module, display an enumerated boxed object containing items related to theorems, postulates, equations, etc. Similar to the zyFigure tag or code, a browser module renders a label for a zyEnum object based on a “type” attribute (e.g., Theorem, Postulates, Equations, etc.) and the corresponding chapter number, section number, and zyEnum object order. For example, a browser modules renders a label for a zyEnum box as “Theorem 3.10.1” if the zyEnum object includes a type=“Theorem” and is in the third chapter, tenth section, and is the first zyEnum object in the tenth section. Similar to the zyFigure tag or code, the zyEnum tag or code include “caption” and “id” attributes, in addition to the “type” attribute. The “caption” attribute instructs the authoring module to configure the zyEnum object such that, when rendered by a browser module, a specified descriptive title is provided for the zyEnum object (e.g., Theorem 3.10.1: The first theorem.). The “id” attribute is used by the authoring module to assign a global identifier (GI) for the zyEnum object. HTML tags may be used to instruct the authoring module to configure the zyEnum object such that, when rendered by a browser module, includes related texts.

The zyExample tag or code instructs the authoring module to create a zyExample teaching object which, when render by a browser module, displays a boxed object that is capable of enclosing one or more other box-type objects, such as a zyFigure, zyTry, zyEnum objects previously discussed. For example, a browser module may render the zyExample object by displaying a long continuous example including multiple figures, trys, and code examples. Similar to the zyFigure tag or code, the authoring module configures the zyExample object with a label based on the corresponding chapter number, section number, and zyExample order. For instance, a browser module renders a zyExample object with a label “Example 3.11.1” if the zyExample object is in the third chapter, eleventh section, and is the first zyExample object in the eleventh section. Similar to the zyFigure tag or code, the zyExample tag or code includes “caption” and “id” attributes. The “caption” attribute instructs the authoring module to configure the zyFigure object which, when rendered by a browser module, a specified descriptive title is provided for the zyExample object (e.g., Example 3.11.1: A first example.). The “id” attribute is used by the authoring module for assigning a global identifier (GI) to the zyExample object. Other teaching objects as well as HTML texts may be embedded in zyExample tags for further instructing the authoring module as to how to configure the zyExample object.

There are various Zyante tags or codes for instructing the authoring module to create referencing type teaching objects. For instance, there are Zyante tags for referencing an animated teaching object, a file, and a teaching object stored in a content database. (See e.g., 1.11 zyHypeAnimation, 1.12 zyFile, and 1.13 zyTool of Appendix 2).

The zyHypeAnimation tag or code instructs the authoring module to create a zyHypeAnimation teaching object which, when rendered by a browser module, displays a box object that references an animation teaching object stored in a particular database, such as a Google Drive. A browser module rendering the zyHypeAnimation object provides a hyperlink which, when clicked or selected, downloads the referenced animation teaching object. The zyHypeAnimation tag or code includes four attributes, “caption”, “file”, “height”, and “width.” The “caption” attribute instructs the authoring module to configure the zyHypeAnimationOjbect such that, when rendered by a browser module, a specified title for provided for the zyHypeAnimation object. The “file” attribute instructs the authoring module to configure the zyHypeAnimation object such that, when rendered by a browser module, the location (e.g., a URL or hyperlink) of the referenced animation teaching object is provided for downloading. The “height” attribute instructs the authoring module to configure the zyHypeAnimation object such that, when rendered by a browser module, the height (in pixels) of the animation as it appears on the page is set. The “width” attribute instructs the authoring module to configure the zyHypeAnimation object such that, when rendered by a browser module, the width (in pixels) of the animation as it appears on the page is set.

The zyFile tag or code instructs the authoring module to create a zyFile teaching object which, when rendered by a browser module, displays a box object that references a file stored in a particular database, such as a Google Drive. A browser module rendering the zyFile object generates a hyperlink which, when clicked or selected, downloads the referenced file. The zyFile tag or code include three attributes, “title”, “id”, and “file.” The “title” attribute instructs the authoring module to configure the zyFile object such that, when rendered by a browser module, a specified title is provided for the zyFile object. The “id” attribute is used by the authoring module to assign a global identifier for the zyFile object. And, the “file” attribute instructs the authoring module to configure the zyFile object such that, when rendered by a browser module, the location (e.g., a URL or hyperlink) of the referenced file is provided for downloading the referenced file.

The zyTool tag or code instructs the authoring module to create a zyTool teaching object render a box object that references a teaching object (e.g., a Javascript based interactive object) stored in a particular database, such as a Google Drive. A browser module rendering the zyTool object generates a hyperlink which, when clicked or selected, downloads the referenced teaching object. The zyTool tag or code include three attributes, “title”, “id”, and “file.” The “title” attribute instructs the authoring module to configure the zyTool object such that, when rendered by a browser module, a specified title is provided for the zyTool object. The “id” attribute is used by the authoring module to a global identifier for the zyTool object. And, the “file” attribute instructs the authoring module to configure the zyTool object such that, when rendered by a browser module, the location (e.g., a URL or hyperlink) of the referenced teaching object is provided for downloading the reference object.

There are Zyante tags or codes for instructing the authoring module to create various types of browser-renderable question set teaching objects, each identified with a prefix of “zyQset.” There is a zyQsetTF tag for instructing the authoring module to create a true or false type question set object; a zyQsetShortAnswer tag for instructing the authoring module to create a short answer question set object; there is a zyQTextAroundAns tag for instructing the authoring module to create a fill-in-the-blank type question set object; there is a zyQSetMultipleChoice tag for instructing the authoring module to create a multiple choice question set object; there is a zyQSetMatch tag for instructing the authoring module to create a matching question set object; there is a zyQSetDetectAnswer tag for instructing the authoring module to create a detect answer type of question set object; and there is a zyQSetSurvey for instructing the authoring module to create a survey type of question set. (See e.g., 1.14 zyQSet tags of Appendix 2).

For instance, there is a zyQsetTF tag or code for instructing the authoring module to create a true or false question set object. Associated with the zyQsetTF (as well as other types of question set object tags) is the zyQ tag for instructing the authoring module to configure the true or false question set object such that, when rendered by a browser module, a question and two selectable possible answers (e.g., true and false) are displayed. Text appearing within opening and closing zyQsetTF tags, but before the first zyQ tag, instructs the authoring module to configure the true or false question set object such that, when rendered by a browser module, a specified text is displayed before the first question for providing instructions related to the one or more questions of the zyQsetTF object.

Nested within opening and closing zyQ tags is a zyQText with an attribute “correct” that instructs the authoring module to configure the true or false question set with the correct one of the two possible answers (e.g., set correct=“true”—true is the correct answer or correct=“false”—false is the correct answer). Additionally, the zyQ tags further instructs the authoring module to configure the true or false question set object such that, when rendered by a browser module, displays a visual indication as to the correctness or incorrectness of the user's selected answer. Additionally, a zyQExpl is also nested within opening and closing zyQtags for instructing the authoring module to configure the true or false question set object such that, when rendered by a browser module, displays an explanation for the correct answer.

The zyQSetTF tag or code includes “truelabel” and “falselabel” attributes that instructs the authoring module to configure the true or false question set object with two selectable answer options, instead of true of false (e.g., Yes or No, Round or Flat, etc.). The zyQSetTF tag also has a “caption” attribute to instruct the authoring module to configure the true or false question set object such that, when rendered by a browser module, a specified title for the zyQSetTF question set object is displayed. Additionally, the zyQSetTF includes an “id” attribute using by the authoring module to assign a global identifier for the zyQSetTF object. The zyQsetTF tag, as well as the other question set types described below, also instructs the authoring module to configure the true or false question set object, such that, when rendered by a browser module, provide an input object for receiving feedback from a user regarding the zyQsetTF object. In response to receiving user's feedback response, a browser module is configured to transmit the information to the server for capturing the information.

The zyQsetShortAnswer tag instruct the authoring module to create a browser-renderable short answer question set object. One or more opening and closing zyQ tags may be nested within opening and closing zyQsetShortAnswer tags, which instructs the authoring module to configure the short answer question set object such that, when rendered by a browser module, displays the following: (1) one or more indicated questions, (2) one or more to input objects (e.g., textbox) for receiving one or more responses to the questions from a user; (3) one or more answer submission buttons (e.g., “Check”) for a user to click or select to submit the one or more responses; and (4) one or more “show answer” buttons for a user to click or select to cause the browser module to display the correct one or more answers, respectively. The zyQsetShortAnswer includes the “caption” attribute to instruct the authoring module to configure the short answer question set object such that, when rendered by a browser module, displays a title for the zyQsetShortAnswer object. Additionally, the tag includes the “id” attribute used by the authoring module to assign a global identifier (GI) to the short answer question set object. The authoring module also configures the short answer object such that, when rendered by a browser module, displays a feedback input object for receiving feedback regarding the question set from a viewing user.

Nested within opening and closing zyQ tags of a zyQsetShortAnswer object is a zyQAns tag for instructing the authoring module to configure the short answer question set object such that, when rendered by a browser module, stores the correct answer for the corresponding question. The zyQAns tag may identify multiple correct answer for each question. The zyQAns tag includes an attribute “preferred” to instruct the authoring module to configure the short answer object such that, when rendered by a browser module, displays the correct answer identified by the “preferred” attribute in response to a user clicking or selecting the corresponding “show answer” button. The zyQAns tag further includes an “ignoreend” attribute to instruct the authoring module to configure the short answer question set object such that, when rendered by a browser module, the object is able to accept an answer that ends with some text (e.g., 8 cows—8 is accepted for answer determination and the text “cows” is ignored). The zyQAns tag further includes “lines” and “columns” to instruct the authoring module to configure the short answer question set object such that, when rendered by a browser module, provides an answer receiving input object (e.g., textbox) with a size indicated by the lines and columns attributes. The zyQAns tag additionally includes “obeycase” and “obeyspace” to instruct the authoring module to configure the short answer question set object such that the answer is case sensitive and whitespace sensitive.

A zyQExpl tag may be included within opening and closing zyQ tags, the zyQExpl for instructing the authoring module to configure the associated question set object such that, when rendered by a browser module, an indicated explanation of the correct answer is displayed. A zyQHint tag may also be included with opening and closing zyQ tags to instruct the authoring module to configure the associated question set object such that, when rendered by a browser module, a hint in response to an incorrect answer received by a user is displayed.

The zyQTextAroundAns tag instructs the authoring module to create a “fill-in-the-blank” type question set object. One or more opening and closing zyQ tags may be nested within opening and closing zyQTextAroundAns tags, which instructs the authoring module to configure the fill-in-the-blank question set object such that, when rendered by a browser module, displays the following: (1) one or more indicated questions, (2) one or more to input objects (e.g., textbox) for receiving one or more responses to the questions from a user; (3) one or more answer submission buttons (e.g., “Check”) for a user to click or select to submit the one or more responses; and (4) one or more “show answer” buttons for a user to click or select to cause the browser module to display the correct one or more answers, respectively. A zyQAnsBox instructs the authoring module to configure the fill-in-the-blank question set object such that, when rendered by a browser module, the location for answer input object is specified. The zyQAns tag instructs the authoring module to configure the fill-in-the-blank question set object with the specified correct answer, which allows the browser module rendering the object to display a visual indicator of correctness or incorrectness based on the response by a user. If the text associated with the question relates to programming code, the zyQTextAroundAns tag includes a “language” attribute to instruct the authoring module to configure the fill-in-the-blank question set object such that, when rendered by a browser module, the programming code is colorized based on the indicated programming language.

The zyQSetMultipleChoice instructs the authoring module to create a multiple choice type question set object. Again, the zyQ tags instruct the authoring module to configure the multiple choice question set object such that, when rendered by a browser module, displays the indicated question provided within opening and closing zyQtags. Nested zyQChoice tags within zyQtags include zyQAns for instructing the authoring module to configure the multiple choice question set object such that, when rendered by a browser module, displays the possible choices; a “correct” attribute specifies the correct choice. The authoring module configures the multiple choice question set object such that, when rendered by a browser module, displays a visual indication of the correctness or incorrectness of the response from a user. Additionally, zyQChoice tag includes a nested zyQExpl tag to instruct the authoring module to configure the multiple choice question set object such that, when rendered by a browser module, displays an indicated explanation for the correct answer. The zyQSetMultipleChoice object includes the “caption” and “id” attributes for the authoring module to provide a title and a global identifier (GI) for the zyQSetMultipleChoice object. The authoring module also configures the multiple choice question set object such that, when rendered by a browser module, feedback input object is provided to receive feedback from a user interacting with the question set object.

The zyQSetMatch tag or code instructs by a browser module to render a matching question set object. Each zyQSetMatch tag includes a zyQMatchLeft and zyQMatchRight to inform a browser module of the correct matching pair so that the browser module is able to provide a visual indicator of correctness or incorrectness based on the response by a user. The zyQSetMatch tag or code also instructs by a browser module to render a “Reset” button which, when clicked or selected by a user, instructs the browser module to re-render the default unanswered question set. The zyQSetMatch object includes the “caption” and “id” attributes to provide a title and a global identifier (GI) for the zyQSetMatch object. The feedback input object is also rendered by a browser module for the zyQSetMatch object.

The zyQSetDetectAnswer tag instructs the authoring module to create a detect the answer type of question set object. The zyQSetDetectAnswer tag can contain multiple nested zyQ tags. Each zyQtag can contain multiple zyQOption tags. Each zyQOption tag contains nested zyQText and zyQExpl tags. The zyQSetDetectAnswer object includes the “caption” and “id” attributes to provide a title and a global identifier (GI) for the zyQSetDetectAnswer object. The authoring module configures the detect the answer question set object such that, when rendered by a browser module, a feedback input object is provided to receive feedback from a user interacting with the question set object.

The zyQSetSurvey tag instructs the authoring module to create a survey type question set object. The zyQSetSurvey object behaves similar to a zyQSetShortAnswer object, except there is no need for a correct answer or hint to be specified. The zyQSetSurvey object includes the “caption” and “id” attributes to provide a title and a global identifier (GI) for the zyQSetSurvey object.

FIG. 5C illustrates a screen shot of an exemplary question set authoring module 560 in accordance with another aspect of the disclosure. The question set authoring module 560 may be configured to be run by a browser module for assisting authors in creating question set type teaching objects. However, it shall be understood that the question set authoring module 560 may be implemented in other manners, such as a non-browser based program or a server-operated program. The question set authoring module 560 is configured to generate the appropriate question set related tags or codes and corresponding attributes based on more intuitive or “laymen” inputs (i.e., non-tag or -code inputs) from an authoring user.

In particular, the question set authoring module 560 comprises an input object 562 (e.g., a drop-down input object) for selecting the type of question set (e.g., true or false, fill-in-the-blank, multiple choice, matching question set, detect answer, and survey). The question set generating module 560 also includes another input object 564 (e.g., a textbox input object) for receiving the question set identifier attribute “id”. Additionally, the question set generating module 560 includes another input object 566 (e.g., a textbox input object) for receiving the “caption” attribute (e.g., a title for the question set).

The question set authoring module 560 includes another input object 568 (e.g., a textbox input object) for receiving an instruction for the question set (e.g., the text before the first zyQ tag). The question set authoring module 560 further includes one or more input objects 570 (e.g., a textbox input object) for receiving one or more questions pertaining to the question sets (e.g., text for the one or more zyQ tags of the question set).

The question set authoring module 560 further includes one or more input objects 572 (e.g., a various types) for receiving one or more answers and attributes pertaining to the one or more questions (e.g., text and attributes for the for the one or more zyQAns of the question set). The question set authoring module 560 includes one or more input objects 574 (e.g., a textbox input object) for receiving text regarding one or more hints related to the one or more questions (e.g., the text for the zyQHint tag). The question set authoring module 560 includes one or more input objects 576 (e.g., a textbox input object) for receiving text regarding one or more explanations for the one or more correct answers (e.g., the text for the zyQExpl tag). Further, the question set authoring module 560 includes control buttons 578 for reordering (up/down arrows) and deleting (X) questions.

The question set authoring module 560 includes a “Generate XML” button type input object 580 to allow a user to initiate the generation of the appropriate XML tags or codes in a window 586 based on the inputs provided by a user via the input objects 562 to 578 discussed above. The generated tags or codes in the window 586 may be copied and paste into a source file that is used by the authoring module to create the corresponding question set object. Alternatively, or in addition, the question set authoring module 560 may be configured to create or modify the source file directly, without having the user copy and paste the code into the source file.

The question set authoring module 560 includes a “Degenerate XML” button type input object 582 to convert XML tags or codes (pertaining to an existing question set) that has been copied into the window 586 into the appropriate inputs requested by the input objects 562 to 578 discussed above (i.e., the reverse process as the “Generate XML” process). This allows the importing of an existing question set for modification purposes. In this regards, once the modification has been performed via the input objects 562 to 578, the “Generate XML” button 580 may be selected again for the module 560 to generate the appropriate XML tags or codes for the modified question set. Finally, the question set generating module 560 also includes a “Clear all fields” button type input object 584 for clearing or resetting all of the input objects 562 to 578.

There are other Zyante tags for instructing the authoring module to create other types of teaching objects. For instance, there is a zyGdocDrawing tag with associated attributes for allowing an author to embed a drawing created using the GOOGLE DOC™ drawing tool, and a zyGdoclmage tag with associated attributes for allowing an author to embed an image directly into a textbook source file. (See e.g., 1.15 zyGdocDrawing and zyGdoclmage of Appendix 2). There is a zyYoutubeVideo tag with associated attributes for embedding a link to a Youtube video. (See e.g., 1.16 zyYoutubeVideo of Appendix 2). There is a zyFootnote tag for creating a footnote at the bottom of a section. (See e.g., 1.17 zyFootnote of Appendix 2). There is a zyLink tag with associated attributes for creating a link to an outside resource. (See e.g., 1.18 zyLink of Appendix 2).

In particular, the zyGdocDrawing tag instructs the authoring module to create a browser-renderable drawing teaching object, wherein the specified GOOGLE DOC™ drawing is embedded in a textbook source file. The zyGdocDrawing tag has height and width attributes to specify the height and width in pixels of the browser rendered drawing. If only one of the height or width attribute is specified, the aspect ratio of the drawing image is maintained. If neither the height nor width attribute is specified, the browser renders the drawing image in its original size. The zyGdocDrawing tag also includes a sizeperc attribute to instruct the authoring module to configure the teaching object such that, when rendered by a browser module, the displayed drawing image has a size being a specified percentage of its original size. The zyGdocDrawing tag also includes a “title” attribute to instruct the authoring module to configure the teaching object such that, when rendered by a browser module, displays a title for the zyGdocDrawing object. The tag also includes an “id” attribute used by the authoring module to assign a global identifier for the zyGdocDrawing object.

The zyGdoclmage tag instructs the authoring module to create a browser-renderable image teaching object, whose image is embedded in the textbook source file. The zyGdoclmage tag has height and width attributes to instruct the authoring module to configure the image object such that, when rendered by a browser module, the displayed image has the specified height and width in pixels. If only one of the height or width attribute is specified, the aspect ratio of the image is maintained. If neither the height nor width attribute is specified, the browser module renders the image in its original size. The zyGdoclmage tag also includes a sizeperc attribute to instruct the authoring module to configure the image object such that, when rendered by a browser module, displays the image with a size being a specified percentage of its original size. The zyGdoclmage tag also includes a “title” attribute to instruct the authoring module to configure the image object such that, when rendered by a browser module, displays a title for the zyGdoclmage object. The tag includes an “id” attribute used by the authoring module to assign a global identifier for the zyGdocDrawing object.

The zyYoutubeVideo tag instructs the authoring module to create a video teaching object such that, when rendered by a browser module, displays a specified Youtube video playable by a selectable hyperlink. The zyYoutubeVideo tag includes a link attribute for specifying the location (e.g., the URL) of the Youtube video. The zyYoutubeVideo tag also includes a “caption” attribute to instruct the authoring module to provide a title for the zyYoutubeVideo object, and an “id” attribute for assigning a global identifier for the zyYoutubeVideo object.

The zyFootnote tag instructs the authoring module to create a footnote teaching object such that, when rendered by a browser module, displays the indicated footnote proximate an end of a section in which the footnote is referenced. The zyFootnote includes an “id” attribute to instruct the authoring module to configure the footnote object such that, when rendered by a browser module, the footnote is reference by the “id” attribute.

The zyLink tag instructs the authoring module to create a teaching object comprising clickable or selectable link to an outside resource. When the link is clicked on or selected by a user, a browser module renders the specified outside resource in a new tab. The zyLink tag includes a “link” attribute to specify the location (e.g., the URL) of the outside resource.

There are Zyante tags for instructing the authoring module to create different types of notification objects. For instance, there is a zyExplore tag that instructs the authoring module to create an explore teaching object such that, when rendered by a browser module, a notification is displayed; the notification indicating other resources related to a section that may be of interest to a user (See e.g., 1.20 zyExplore of Appendix 2). There is a zyCaution tag that instructs the authoring module to create a caution notification object. (See e.g., 1.21 zyCaution of Appendix 2). There is a zyBlock tag that instructs the authoring module to create text object that is separate from the main body of the associated section. (See e.g., 1.22 zyBlock of Appendix 2). There is a zyCrossRef tag with associated attributes that instructs the authoring module to create a cross reference object such that, when rendered by a browser module, a reference to another Zyante tag, such as a tag for a different section, chapter or offering, is displayed. (See e.g., 1.25 zyBlock of Appendix 2).

In particular, the zyExplore tag or code instructs the authoring module to create an explore teaching object such that, when rendered by a browser module, specifies other resources that may be of interest to a user. The text regarding the other resources is situated within opening and closing zyExplore tags. The authoring module configures the explore teaching object such that, when rendered by a browser module, displays the text within a colored box that is labeled “Exploring further:” The zyExplore object may be placed at an end of a section to provide the viewing user information regarding other resources related to the subject matter of the current section.

The zyCaution tag or code instructs the authoring module to create a caution notification teaching object such that, when rendered by a browser module, displays cautionary emphasizing an area where a user should take caution. The text regarding the caution is situated within opening and closing zyCaution tags. A browser module renders the text prepended by an underlined word “caution” followed by a colon (e.g., “Caution: Beginning programmers often confuse . . . ”).

The zyBlock tag instructs the authoring module to create a browser-renderable text box teaching object such that, when rendered by a browser module, displays specified text separate from the main body of the associated section. The text is situated within opening and closing zyBlock tags. A browser module renders the text within an unlabeled colored box. The zyBlock tag or code includes a “nobox” attribute, which, when is set to “true,” the colored background does not appear. Otherwise, when the nobox attribute is not specified or equal to “false”, a colored background is provided for the text.

The zyCrossRef tag or code instructs the authoring module to create a cross-referencing teaching object such that, when rendered by a browser module, provides a reference another Zyante object, such as a different section, chapter or offering (content object). When the reference to another tag is situated between opening and closing zyCrossRef tags, a browser module renders the name of the referenced tag in place of the zyCrossRef tags. The zyCrossRef tag has four attributes to specify the location of the referenced tag, “offering”, “sectionId”, “tag”, and “id”. The “offering” attribute refers to the offering the referenced tag appears (e.g., “matlab”, “dm”, etc.). The “sectionId” is the value of the “id” attribute of the referenced “zySection.” The “tag” attribute specifies the type of tag being referenced (e.g., “zyTable”, “zyTool”, etc.). And, the “id” attribute is the value of the “id” attribute of the referenced tag.

There are various Zyante tags related to mathematical or programming aspects. For instance, there is a zyMatrix tag with associated attributes for instructing the authoring module to create a browser-renderable matrix teaching object. (See e.g., 1.19 zyMatrix of Appendix 2). There is a zyProof tag for instructing the authoring module to create a browser-renderable proof teaching object. (See e.g., 1.23 zyProof of Appendix 2). There is a zyLatexEquation with associated attributes for instructing the authoring module to create a browser-renderable equation teaching object. (See e.g., 1.24 zyLatexEquation of Appendix 2). There is a zyDE tag with two optional subtags zyProgram and zyInput for instructing the authoring module to create a browser-renderable teaching object that provides an executable programming script with optionally a pre-entered program and a pre-entered input. (See e.g., 1.26 zyDE of Appendix 2). There is a zyScript for instructing the authoring module to create a teaching object including an executable script. (See e.g., 1.27 zyScript of Appendix 2).

The zyMatrix tag or code instructs the authoring module to create a browser-renderable matrix teaching object. A row of matrix values is created by separating the values by spaces, and a comma is used to separate one row from another row of values. (e.g., zyMatrix 1 2, 3 4 /zyMatrix). In response to appropriate values situated between opening and closing zyMatrix tags, the authoring module configures the matrix object such that, when rendered by a browser module, the standard representation of the matrix is displayed with the typical opening and closing brackets. The zyMatrix has three attributes, “center”, “label”, and “super.” The “center” attribute, when set “true,” instructs the authoring module to configure the matrix object such that, when rendered by a browser module, the matrix is horizontally center within the webpage of the textbook data object. The “label” attribute instructs the authoring module to configure the matrix object such that, when rendered by a browser module, the indicated label is provided to the left of the matrix. The “super” attribute instructs the authoring module to configure the matrix object such that, when rendered by a browser module, displays the matrix with the indicated superscript.

The zyProof tag or code instructs the authoring module to create a proof teaching object. The text regarding a proof is situated within opening and closing zyProof tags. A browser module rendering the proof object bolds the word “Proof.” before the specified text and displays a square symbol (▪) following the text (e.g., Proof. This is the text of a proof. ▪).

The zyLatexEquation tag or code instructs the authoring module to create an equation teaching object that includes a specified LaTex equation. A browser module rendering the equation teaching object provides an automatic typeset appropriate for equations. The zyLatexEquation object has an attribute “inline” attribute which, when set to “true”, specifies that the rendered equation is on the same line at which the LaTex equation appears. Otherwise, the browser module renders the equation on the following line.

The zyDE tag or code instructs the authoring module to create an executable programming script object. A browser module rendering this object displays the programming script within a box and includes an input object for initiating the execution of the script by a user. The browser module also displays the results of the executed programming script within another portion of the box object. The zyDE tag has two optional associated subtags, zyProgram and zyInput. The zyProgram tag is used to specify the programming script. The zyInput tag is used to specify a pre-entered input. The zyDE has five attributes, “id”, “language”, “stacked”, “input”, and “reset.” The “id” attribute is used for creating a global identifier for the zyDE object. The “language” attribute is used to specify the programming language of the script. The “stacked” attribute, when set to true, instructs the authoring module to configure the script object such that, when rendered by a browser module, the results or output of the executed script is provided in an area of the box object below the input object. The “input” attribute, when set to true, instructs the authoring module to configure the script object such that, when rendered by a browser module, a user is allowed to change the input value to the script. And, the reset attribute, when true, instructs the authoring module to configure the script object such that, when rendered by a browser module, a reset button is provided to allow a user to reset the input value to the preentered value.

The zyScript tag or code instructs the authoring module to create a browser-renderable object that interprets a script enclosed within opening and closing zyScript tags as a browser controlling script (e.g., as a Javascript).

There are various Zyante tags for instructing the authoring module to create teaching objects related homework problems, problem statements, mechanisms for checking the student's answer, providing hints, and providing a solution.

Commonly related subjects, such as the C++ programming language and the Java programming language, have extensive overlap. It is desirable to create textbook material that has a single source for common material, thus reducing redundancy, which may mean less initial development time, easier maintenance, and fewer errors. Thus, a textbook data object's source may have common portions, and then subject-specific portions delineated by zyVersion tags that indicate a specific version such as Java, or a list of versions like “C, Java”. Upon generating a specific textbook, a specific version can be specified, causing common material to be generated along with material inside zyVersion tags that include Java in their version list.

Similarly, there are tags that instructs the authoring module to automatically name or format browser-renderable teaching objects based on the specific version being generated. The zyFunction tag instructs the authoring module to configure browser-renderable teaching objects to automatically insert the language-specific word for a function, such as “function” for the C and C++ programming languages, or “method” for the Java language. (See e.g., 1.28 zyFunction of Appendix 2). And, there is a zyFctName tag that instructs the authoring module to configure browser-renderable teaching objects to capitalize a function's name using a style common for the specific version, such as MyFct for C or C++, and myFct for Java. (See e.g., 1.29 zyFctName of Appendix 2).

The zyDataMember tag or code instructs the authoring module to configure a browser-renderable teaching object to automatically insert the language-specific word for a data member, such as “data member” for the C and C++ programming languages, or “field” for the Java language. (See e.g., 3.28 zyFunction of Appendix 3).

Some Zyante tags relate more specifically to the authoring process rather than the content itself. For example, a zypInfo tag captures information about the status of an item, such as a particular teaching tool or an entire section, within textbook object. Such information might include the person who created the item, the date, a comment indicating what was done or what needs to be done to that item, the completion status of an item, etc. These tags may be read during processing of the source file and used in various ways such as to create a summary of a textbook object's current status, to notify individuals such as via email of an item's completion or the need for the individual's attention to the item, etc.

A zyAnimator tag or code instructs the authoring module to create a browser-renderable animated teaching object such that, when rendered by a browser module, displays a user-initiatable animation. An author may use an animation authoring module described later herein to generate the appropriate tags or codes for instructing the authoring module to create the specified animated teaching object (See e.g., 3.29 zyFunction of Appendix 2). During rendering, the contents inside the zyAnimator tag is passed to a browser module, which renders the animation. The zyAnimator tag includes an “id” attribute used by the authoring module to assign a global identifier (GI) to the zyAnimator object, and a “caption” option that instructs the authoring module to configure the animated teaching object such that, when rendered by a browser module, displays a title for a box object enclosing the animation.

A zyHTML tag or code allows for authors to re-order items enclosed by opening and closing zyHTML tags (See e.g., 3.30 zyFunction of Appendix 2). The zyHTML tag includes an “id” attribute for generating a global identifier (GI) for the zyHTML object. Additionally, the zyHTML tag includes a “caption” attribute to specify a description of the items enclosed by zyHTML tags. This improves the readability to facilitate the reordering of items by authors.

With reference back to FIG. 5A, instructors, using document editing modules running on the instructor user devices 506-1 to 506-M or on the document editing module server 508, may simultaneously or non-simultaneously create, access, and modify a textbook source file. Instructors edit the textbook source file by adding and/or deleting HTML codes as well as Zyante tags in order to modify the textbook source file as desired. One or more users operating the one or more user devices 506-1 to 506-M provide the textbook source file as an input to the authoring module running on the authoring module server 510 to generate one or more chapter objects, one or more section objects within each chapter object, and a plurality of teaching objects within each section object. The document editing server 508 provides version control and synchronizes the latest version of the textbook source file with the version residing in the server 504.

The textbook data object may exist in source form involving the Zyante tags. An author (an instructor or other creator of a textbook data object) may apply a translator that is part of the authoring module, applying the translator to a small portion of the source such as one section or one teaching tool or to a large portion such as an entire chapter or to all source, resulting in a conversion of the source into the target HTML, Javascript, CSS, and/or other formats used for the delivery of the textbook data object to students. The target format may be provided merely as a local preview to the author. An author may share a local preview by instructing the authoring tools to create a persistent sharable webpage containing the preview, which can then be shared with other authors, editors, etc. The target format may be integrated into a full-book preview of a textbook data object. The target format may be integrated into a textbook data object for use by instructors and students. A preview can be migrated into an in-use textbook data object.

The authoring module may use Google Docs or a similar cloud-based document editor for capturing source files. The authoring module may include add-ons to the cloud-based document editor to support what-you-see-is-what-you-get (WYSIWYG) editing of the source files to replace certain Zyante tags. For example, the authoring module may allow a table to be drawn using the document editors built-in table drawing feature that draws the table graphically, and the authoring module automatically translate such a table into the appropriate Zyante or HTML tags. The authoring module may add their own graphical or WYSIWYG features to the document editor, such as a button that adds a new figure, relieving the author from having to write the Zyante tags for a figure.

Similarly, the authoring module may provide other tools to assist with authoring of the source in a graphical or WYSIWYG manner. For example, as previously discussed with reference to FIG. 5C, the authoring module may allow an author to create or edit a question set object by using a question set author module, rather than typing Zyante tags. The format may allow for selection of the question type, for adding new questions, for typing the answer, hints, or explanation, etc. The authoring module then translate such information into the appropriate Zyante tags and content stored in a source file. The authoring module can translate those tags back into the graphical format for subsequent editing.

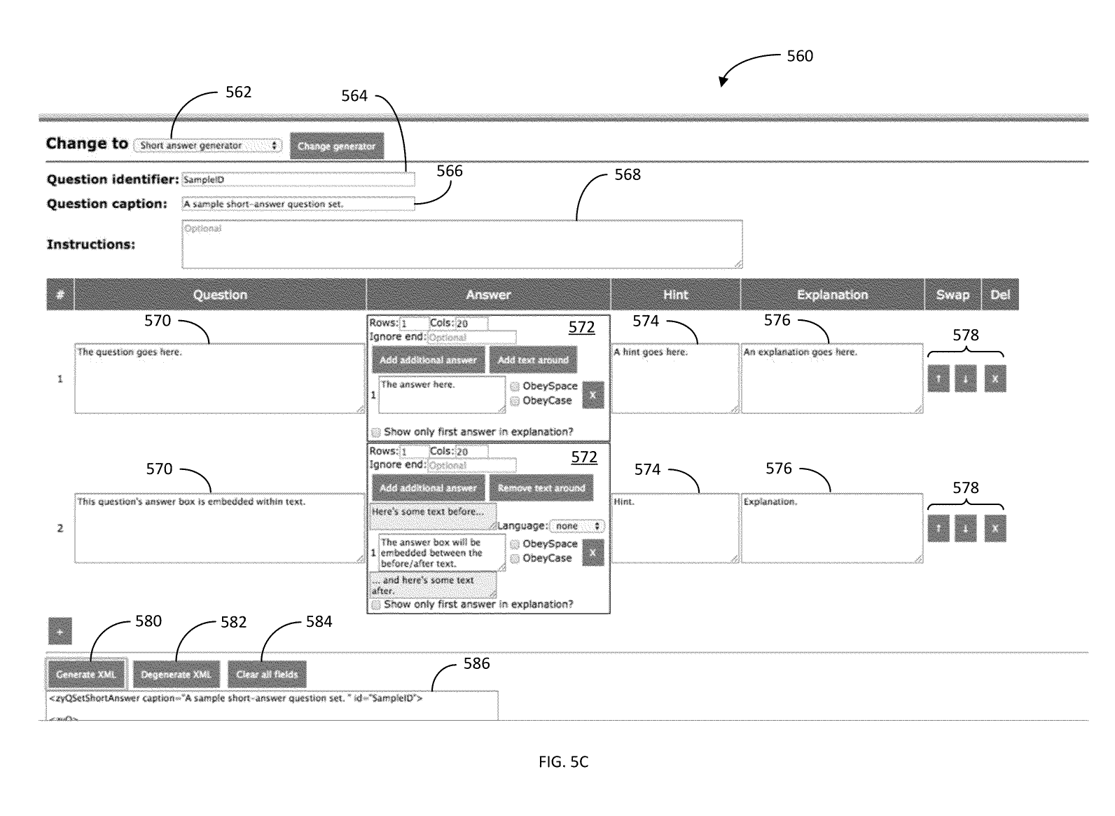

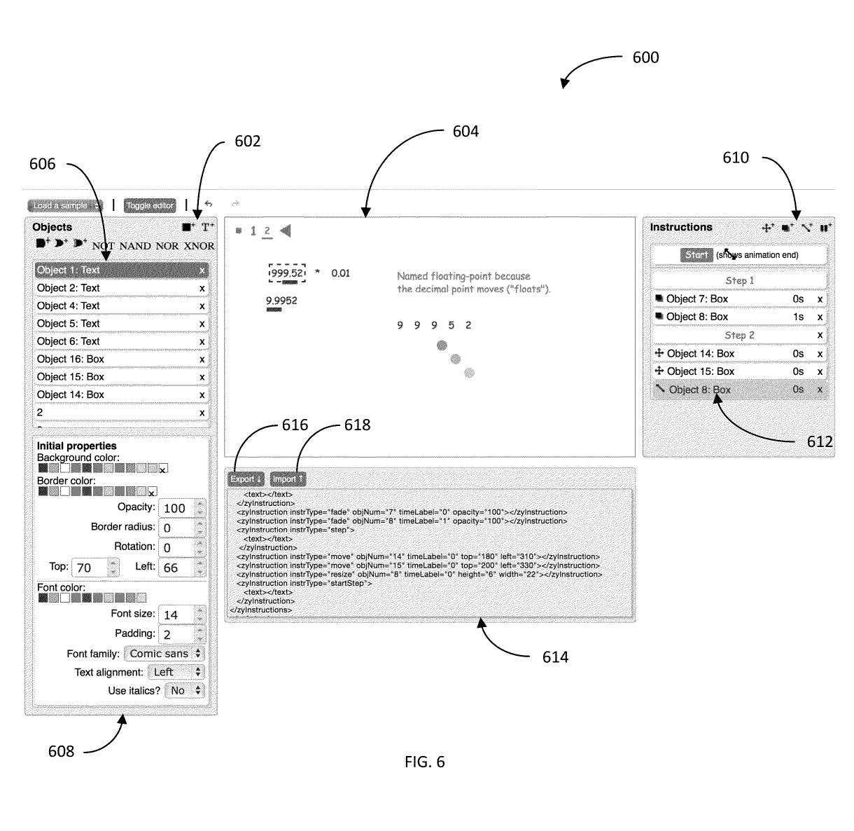

FIG. 6 illustrates a diagram of an exemplary software module 600 for creating animated teaching objects in accordance with another aspect of the disclosure. The animation authoring module 600 may be configured as a software component of a browser module, or in other manners. The animation authoring module 600 facilitates users (e.g., instructors and students) in creating animated teaching objects for use as proposed animated teaching objects, textbook authorized animated teaching objects, proposed global animated teaching objects, and authorized global animated teaching objects, as previously discussed. The animation authoring module 600 may be operated using any of the instructor user devices 106-1 to 106-M and 501-1 and 506-M, and any of the student user devices 108-1 to 108-N. The animation authoring module 600 may run on the authoring module server 510 or other related server (accessible by users via a network), or on any of the aforementioned user devices.

The animation authoring module 600 is configured to graphically and visually allow a user to create a desired teaching animation, and includes a translation (exporting) component to generate the appropriate codes (e.g., HTML codes with XML conforming Zyante tags) for generating the animated teaching object in a textbook source file, such as one used to render a textbook data object. A tutorial guide of the animation authoring module 600 is provided herein as Appendix 3.

More specifically, the animation authoring module 600 comprises an input object 602 (e.g., clickable or selectable icons) for introducing new objects into the animation (See e.g., 2. Adding objects of Appendix 3). For example, the input 602 includes a T⁺ soft-button for introducing text objects into the animation, a [symbol] ⁺ soft-button for introducing pre-created graphics objects into the animation, and soft-buttons for introducing various logic gate symbols, such as an AND-gate, OR-gate, Exclusive-Or gate, and others into the animation. For instance, when the an add-object soft-button is selected (e.g., clicked on using a pointing device (e.g., a mouse)), a corresponding object is placed inside a preview animation window or pane 604 and a reference to the object is placed in a list of objects pane 606. An object may also be added by duplicating an already-existing object. This may be done by selecting (e.g., right-clicking on) the already-existing object and selecting “Duplicate.”

Properties of already-existing objects may also be modified using the animation authoring module 600 (See e.g., 3. Object properties of Appendix 3). Modifying an already-existing object entails clicking on or selecting the object in the preview animation pane 604 or clicking on or selecting the reference to the object in the list of objects pane 606. A selected object may be indicated by a highlighting visual attribute, such as a dotted outline around the object. The animation authoring module 600 includes a list of editable properties 608 for the selected object. For a text object, the editable properties include background color upon which the text is overlaid, border color of a border surrounding the text, opacity of the text object, border (corner) radius of the border surrounding the text, rotation or angular orientation of the text, top/left (location of object within preview animation pane 604—measured with reference to the top-left corner of the pane 604), font attributes, such as font color, font size, padding (space between text and object border), font family, text horizontal alignment (e.g., left, right, center, full justification), and use italics. The list of editable properties for a selected graphics object may have at least the same portion of editable properties as a text object, but may not include the font editing section.

The animation authoring module 600 provides for an input object for deleting already-existing objects by, for example, clicking the corresponding “x” symbol next to the object reference in the list of objects pane 606. (See e.g., 4. Deleting objects of Appendix 3). The animation authoring module 600 provides for controlling the display of overlaid or stacked objects. (See e.g., 5. Bring an object forwards/backwards of Appendix 3). For instance, stacked objects are referenced in the list of objects pane 606 in the order of being most in the foreground to being most in the background (it could be ordered in the opposite manner, i.e., from most in the background to most in the foreground). A selected object of a stacked set of objects may be moved more into the foreground or more into the background by selecting (e.g., clicking on) and dragging the reference to the object in the list of objects pane 606 towards the top or bottom of the list, and unselecting (e.g., unclicking) at the desired position. In addition, an object may be brought to the most foreground position or most background position by clicking or selecting the object in the preview animation pane 604, which brings up a menu to allow a user to select “Bring to front” or “Bring to back.”

The animation authoring module 600 also comprises an animation input object 610 for producing animation of the selected object. The animation input object 610 has a “Add move instruction” icon [symbol] for moving the selected object in accordance with the desired animation. (See e.g., 6. Move instruction of Appendix 3). Moving an object for animation purposes entails: (1) clicking on or selecting the object in the preview animation pane 604 or the object reference in the list of objects pane 606 (the selected objected is highlighted by a dotted outline); (2) clicking on or selecting the “Add move instruction” icon [symbol] , which causes a box to appear with editable “Top” and “Left” values (relative position from the top-left corner of the preview animation pane 604); and (3) adjusting the “Top” and “Left” values or selecting, dragging, and unselecting the object at the desired position for the object. In response to the “Add move instruction”, a reference to the instant “Add move instruction” is placed in a list of chronological animation instructions pane 612.

The animation control 610 has a “Fade instruction” icon [symbol] for causing the selected object to fade in or fade out in accordance with the desired animation (See e.g., 7. Fade Instruction of Appendix 3). Fading in or out an object entails: (1) clicking on or selecting the object in the preview animation pane 604 or the object reference in the list of objects pane 606 (the selected objected is highlighted by a dotted outline); (2) clicking on or selecting the “Add fade instruction” icon [symbol] , which causes a box to appear with an editable “Opacity” value; and (3) adjusting the “Opacity” value to achieve the desired fading or opacity of the object in accordance with the desired animation. In response to the “Fade instruction”, a reference to the instant “Fade instruction” is placed in the list of chronological animation instructions pane 612.

The animation control 610 has a “Resize instruction” icon [symbol] for resizing the selected object in accordance with the desired animation (See e.g., 8. Resize Instruction of Appendix 3). Resizing an object entails: (1) clicking on or selecting the object in the preview animation pane 604 or the object reference in the list of objects pane 606 (the selected objected is highlighted by a dotted outline); (2) clicking on or selecting the “Resize instruction” icon [symbol] , which causes a box to appear with editable “Height” and “Width” values; and (3) adjusting the “Height” and “Width” value to achieve the desired resizing of the object in accordance with the desired animation. In response to the “Resize instruction”, a reference to the instant “resize instruction” is placed in the list of chronological animation instructions pane 612.

The animation control 610 has a “Scene” icon [symbol] for controlling a timing of the ending of a previous scene and the start of a new scene. (See e.g., 9. Starting Scene and animation steps of Appendix 3). A scene is an animation that continues from beginning to end without a user needing to click or select any items for the scene to continue. For example, a scene may end at a time when the animation requires one or more inputs from a user (e.g., inputs a value in an input object and/or selects a play button). Once the user provides the one or more inputs, the next scene is commenced until it ends, which may be at the end of the animation or not at the end of the animation if there are one or more scenes to follow.

Adding a scene entails clicking on or selecting the “Scene” icon [symbol] , which adds a reference to the scene in the list of chronological animation instruction pane 612, and also adds a selectable scene caption in the preview animation pane 604. A default scene caption, the number pertaining to order of the scene in the animation, is provided. A user may change the caption of the scene by clicking or selecting the reference to the scene in the list of chronological animation instructions pane 612 or double clicking the scene caption in the preview animation pane 604.

An animation may be created by making a desired list of animation instructions, which are specified in the list of chronological animation instructions pane 612. (See e.g., 10. Instruction ordering and timing of Appendix 3). As previously discussed, the animation authoring module 600 executes animation instructions in accordance with the list of chronological animation instructions pane 612. An authoring user may click or select the scene (1, 2, 3, etc.—default being scene 1) and the play button [symbol] to initiate the playing of the entire animation or corresponding scene to completion in the preview animation pane 604. Additionally, the animation authoring module 600 provides a user a static view of the animation in the preview animation pane 604 based on and in response to the user clicking or selecting one of the instructions in the list of chronological animation instructions pane 612 (e.g., the static view of the animation immediately before or after the execution of the selected animation instruction).

The animation authoring module 600 facilitates the editing of the current animation by a user inserting (clicking or selecting one of the animation input objects 610, which insert the corresponding instruction after the selected animation instruction), deleting (clicking or selecting “x” in the selected animation instruction), and reordering (selecting, dragging, and unselecting the selected animation instruction to another position on the list) the animation instructions in the list of chronological animation instructions list 612.

Additionally, the animation authoring module 600 allows a user to control the speed of the animation. When an animation instruction in the list of chronological animation instructions pane 612 is clicked on or selected, the animation authoring module 600 presents a user an input object (e.g., a textbox) for entering a timing parameter or attribute associated with the selected animation instruction. The timing parameter specifies the delay in executing the selected animation instruction from the completion of the immediately previous animation instruction. For example, a delay of zero (0) second causes the animation authoring module 600 to execute the selected animation instruction immediately after completion of the immediately previous animation instruction. A delay of one (1) causes the animation authoring module 600 to execute the selected animation instruction after a one (1) second delay after the completion of the immediately previous animation instruction. The box also allows a user to cause the previous and the selected animation instructions to be executed simultaneously by selecting “-” for the delay option.

The animation authoring module 600 allows a user to convert the created animation into browser control tags or codes, such as HTML tags and XML conforming Zyante tags for inclusion (e.g., copy and paste) into a textbook source file for rendering a textbook data object. (See e.g., 12. Export an animation of Appendix 3). In this regards, the animation authoring module 600 includes an Export button 616 to cause the module 600 to generate the resulting codes associated with the created animation in a code window or pane 614. As discussed, a user may be able to copy and paste the resulting codes into a textbook source file for creating an animated teaching object. Alternatively, or in addition, the animation authoring module 600 may be configured to create or modify the source file directly, without the user having to copy and paste the codes into the source file.

Similarly, the animation authoring module 600 allows a user to import an animation for viewing and/or further editing using the module 600. (See e.g., 11. Import an animation of Appendix 3). To effectuate the importation of an animation, a user copies and paste the XML-compliant tags or codes corresponding to the imported animation into the code pane 614. The user then clicks on or selects an import button 618. In response to the selection of the import button 618, the animation authoring module 600 populates the list of objects pane 606 including each object's properties, and the list of chronological animation instructions pane with the corresponding parameters based on the imported tags or codes. A user may then use the animation authoring module 600 to view and/or edit the imported animation by, for example, adding, deleting, reordering, and changing attributes of animation objects, and adding, deleting, reordering, and changing attributes of animation instructions, as previously discussed.

The animation authoring module 600 provides additional functions, such as allowing a user to: (1) resize the preview animation pane 604 (See e.g., 13. Resizing the Preview pane of Appendix 3); and (2) toggle between full screen and non-full screen views of the preview animation pane 604 (See e.g., 14. Toggle animation of Appendix 3. A sample animation with corresponding browser control tags or codes is provided in the tutorial for the animation creation module 600. (See e.g., 15. Sample animation of Appendix 3).

The animation authoring module 600 may run entirely in a web browser, avoiding the need to install a program on a local computer. Running in a browser also allows animation development on platforms other than traditional computers, such as on pad, e-readers, or smartphones.

The animation authoring module's XML output using zyTags can be inserted directly into a textbook's source file. Coupled with an appropriate simulation engine, the animation may then be rendered in the final textbook data object, without the need for separate files for such animations. Of course, the XML output could alternatively be stored in a separate file provided with the textbook data object, or a combination of XML in the source document and in separate files may be used. Further, the browser control tags or codes associated with an animated teaching object instructs the browser module to render a static view of the animation at completion as a default view (view prior to animation being started) of the animated teaching object.

The use of Zyante tags to capture animated content allows for new modes of animated content development. Animations can be edited by authors directly via text editing of the Zyante tags, such as adding a new move instruction, modifying text, etc. Furthermore, an animation can be simultaneously edited by multiple authors using a cloud-based document editor like Google Docs. An animation can be easily copy-pasted using standard text editors. The authoring module can automatically read the Zyante tags from a source document into the animation module for further editing in the graphical tool, and re-translate the animation back to Zyante tags stored in the source document. The animation module itself can be integrated with the cloud-based document editor such that multiple authors can simultaneously edit an animation similarly to how they can simultaneously edit a text document.

Appendix 4 provides a listing of the XML-compliant zy tags associated with an animated teaching object. An animated teaching object is created or delineated with opening and closing zyAnimator tags or codes. The zyAnimator tag includes a plurality of attributes, “id”, “caption”, “height”, “width”, “selectedlnstr”, “selectedObj”, “numObjsEverCreated”, and “loadonDemand.”

Each object of an animated teaching object is surrounded by opening and closing zyObject tags or codes. The zyObject tag includes attributes for defining the properties of the corresponding object, as previous discussed. These attributes include “objNum”, “objType”, “ObjName”, “top”, “left”, “opacity”, “border-radius”, “color”, “background-color”, “font-size”, “font-style”, “font-family”, “padding-left”, “padding-right”, “padding-top”, “padding-bottom”, “border-width”, “border-style”, “border-color”, and “transformDeg.”

Each animation instruction of an animated teaching object is surrounded by opening and closing zyInstruction tags or codes. The zyInstruction tag includes attributes for defining the properties of the corresponding instructions, as previous discussed. Each zyInstruction includes an “instrType” attribute for specifying the type of animation instruction, “step1” (scene 1), “move”, “fade”, “resize”, “step”, and “startStep.” With regard to the zyInstruction tag for a move animation instruction, this tag further includes the following attributes: “objNum”, “timeLabel”, “top”, and “left.” With regard to the zyInstruction tag for a fade animation instruction, this tag further includes the following attributes: “objNum”, “timeLabel”, and “opacity.” With regard to the zyInstruction tag for a resize animation instruction, this tag further includes the following attributes: “objNum”, “timeLabel”, “height”, and “width.”

Other tags or codes associated with an animated include the zyCode tag or code previously discussed; a text code for providing a caption for each scene or step; and a zyCanvas code including “height” and “width” attributes for sizing the animation.

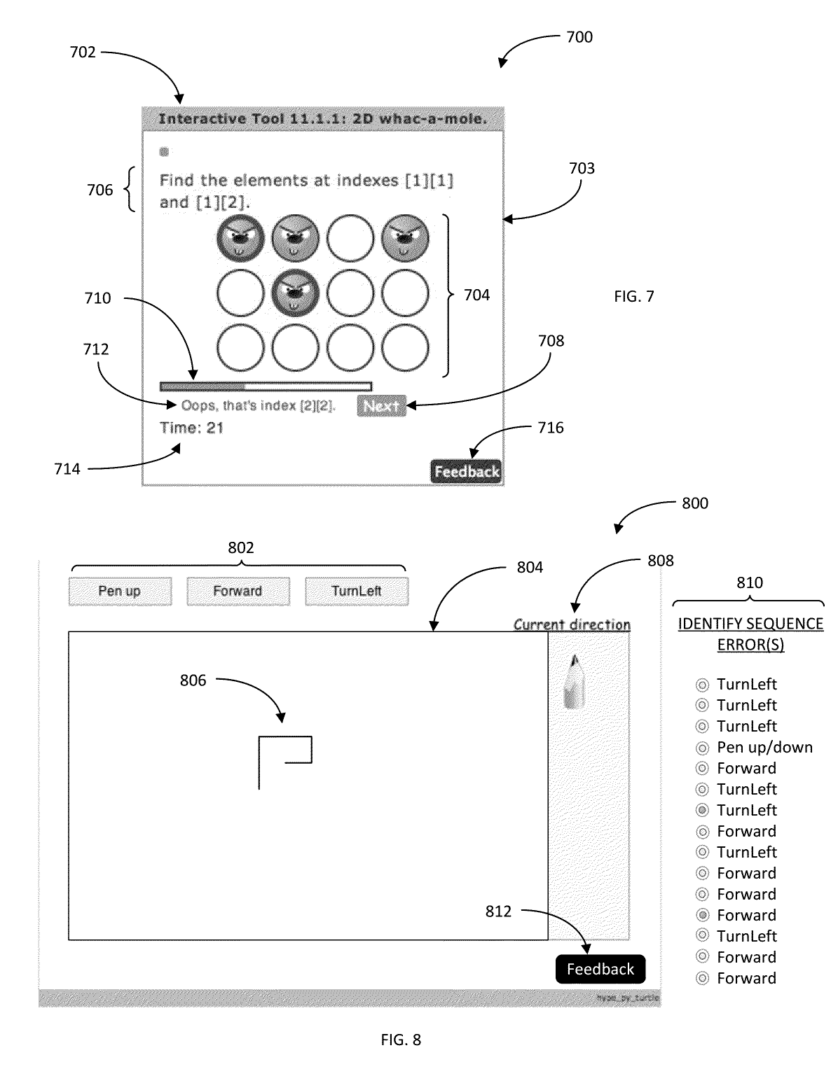

FIG. 7 illustrates a diagram of an exemplary animated teaching object 700 in accordance with another aspect of the disclosure. The animated teaching object 700 has a similar concept as a “whac-a-mole” game often found in video arcades. The animated teaching object comprises a title section 702 situated at a top portion of the object, and including a text describing and numbering the animated teaching content object; the text being inside a rectangular window dropped with a specified background color. The Zyante tag, zyTool, may be used to create the title section 702, workspace or box 703, and feedback input subobject 716 for the animated teaching object 700.

This particular animated teaching object 700 includes an array of graphical subobjects 704. In this example, the array is a rectangular array having a dimension of 3 rows and 4 columns. It shall be understood that the array may be configured differently, including square arrays, circular arrays, star arrays, diamond arrays, and other array shapes. Also, in this example, the graphical objects are each configured as a circle, but some include a particular graphic drawing inside the circle (e.g., an animated face of a mole). Additionally, in accordance with this example, those circles that have graphics therein are possible (selectable or clickable) answers, and those circles that do not have graphics are not possible answers. Again, it shall be understood that the array and array subobjects may be configured differently pursuant to the teaching objectives of the animated teaching object 700. For example, rather than an array of circles, the animated teaching content object may include a list of equations, or a list of computer program statements, and the mole or similar graphics may be overlaid or underlaid on such items.

The animated teaching object 700 may further include a question or instruction section 706. In this example, the question or instruction section 706 asks the user to find indexes [1][1] and [1][2] (i.e., the array subobjects that are situated in row 1, column 1 and row 1, column 2, respectively). Likewise, the section may ask the user to find particular equations or program statements. The animated teaching object 700 includes a result section 712 to indicate whether the user responded to the question or instruction in a correct or incorrect manner. For instance, if the user clicked on the array objects in row 1, column 1 and row 1, column 2, the result section 712 would indicate that the response was correct. Additionally, the appearances of the array objects may change in response to a correct selection, such as adding a green border around the array object (See e.g., array object at row 1, column 1).

However, in this example, the user correctly selected the array object in row 1, column 1, but incorrectly selected the array object in row 2, column 2 instead of the correct array object in row 1, column 2. Accordingly, the result section 712 indicates the error to the user, “Oops, that's index [2] [2].” Additionally, the appearance of the incorrect array object is changed to further provide an indication of the error. In this example, the border surrounding the incorrectly selected array object is red.

The animated teaching object 700 further includes a “Next” clickable button 708 to allow the user to proceed to the next question or instruction. Additionally, the animated teaching object 700 includes a timer 714 to end the operation of the animated teaching object 700 after a specified time from the start of the operation of the tool by a user. This provides a time element to answering of the questions presented by the animated teaching object 700. As previously discussed, the animated teaching object 700 includes a feedback input object 716 to allow users to provide comments and/or ratings regarding the animated teaching object 700. As previously discussed, a textbook data object incorporating the interactive teaching tool is able to capture the comments and/or ratings from users, and present them to an associated one or more instructors. Additionally, as previously discussed, a student data object may also be modified based on the student's interaction with the animated teaching object 700 previously discussed.

FIG. 8 illustrates a diagram of another exemplary animated teaching object 800 in accordance with another aspect of the disclosure. The animated teaching object 800 is configured to teach proper sequencing of instructions. The animated teaching object 800 comprises a section 802 listing a limited set of drawing operations. For instance, in this example, the limited set of drawing operations include a pen up/down operation (“Pen up”), a move forward operation (“Forward”), and a turn left operation (“TurnLeft”).

The animated teaching object 800 further comprises a drawing object window 804 that includes a drawing object 806 used to exemplify proper sequencing in drawing the object 806. The animated teaching object 800 also includes a current direction indicator 808 to indicate the current movement associated with the Forward drawing instruction. Additionally, the animated teaching object 800 includes a question or instruction section 810 that asks the user to respond in a correct manner. For instance, in this example, the question or instruction section 810 asks the user to identify one or more errors in the following drawing sequence associated with the drawing object 806 inside the drawing object window 804. Further, in accordance with this example, the section 810 provides a list of the limited drawing instructions 802 and a radio button next to each instruction. A user is asked to identify the error in the sequence by selecting the one or more radio buttons associated with one or more errors in the sequence.

Considering the drawing example, the initial direction of the pen is upward and the starting point of the drawing is the rightmost end. If only left turn operations are available, in order to initially draw a rightward horizontal line, three turn left operations are needed (e.g., a first left turn changes the direction to left, the second left turn changes the direction to down, and the third left turn changes the direction to right). Thus, the first three TurnLeft operations in the sequence are correct. Next, according to the drawing, there is a first leg heading rightward. To draw this leg, a Pen up/down instruction is needed to put the pen down, followed by a Forward instruction. Thus, the next two instructions in the sequence (Pen up/down and Forward) are correct.

Next, according to the drawing, the second leg moves upward. To draw this leg, a TurnLeft operation is needed to change the direction to upwards and a Forward operation is needed to draw the second leg of the drawing. Thus, the correct sequence for the second leg is TurnLeft and Forward. However, according to the sequence, there are two TurnLeft operations. Thus, the second TurnLeft operation is incorrect. Thus, a user would select the radio button associated with that second TurnLeft after the first Forward instruction, as indicated.

Next, according to the drawing, the third leg moves leftward for a length of two Forward commands. Thus, to draw the third leg from the end of the second leg, a TurnLeft instruction is needed followed by two Forward commands. According to the sequence, there is a TurnLeft operation followed by three Forward operations. Thus, there is another error in the sequence in that there are three consecutive Forward commands, when there should only be two. Again, the user identifies the error in the sequence by selecting the radio button associated with the extra Forward command. The remaining instructions in the list are correct.

Similar to the previously-mentioned animated teaching object 700, the animated teaching object 800 includes a feedback input object 812 to allow users to provide comments and/or ratings regarding the interactive teaching tool 800. As previously discussed, a textbook data object incorporating the interactive teaching tool 800 is able to capture the comments and/or rating from users, and present them to an associated one or more instructors. Additionally, as previously discussed, a student data object may also be modified based on the student's interaction with the interactive teaching tool 800 previously discussed.

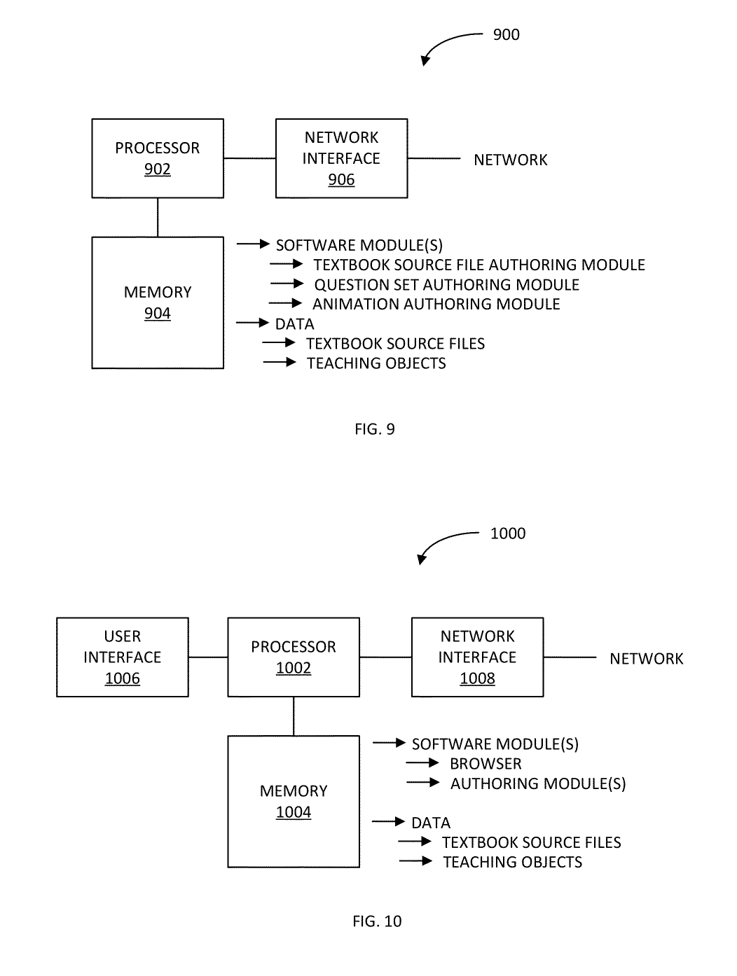

FIG. 9 illustrates a block diagram of an exemplary server 900 in accordance with another aspect of the disclosure. Any server previously described herein may be configured similar to the exemplary server 900. The server 900 comprises a processor 902, a memory device 904, and a network interface 906.

The processor 902 performs the various operations of the server 900 under the control of one or more software modules stored in the memory device 904. The processor 902 may be any type of processor including, but not limited to, microprocessors, reduced instruction set computer (RISC) processors, microcontrollers, etc. The one or more software modules may include a textbook source file authoring module, a question set authoring module, and/or an animation authoring module, as previously discussed.

As discussed, the memory device 904 stores various information to implement the various operations of the processor 902. Such information includes one or more software modules, such as the textbook source file authoring module, a question set authoring module, and/or an animation authoring module. Additionally, memory device 904 may store data, such as textbook source files and source files for teaching objects. The memory device 904 may be any type of non-volatile memory, such as magnetic hard drives, solid state drivers, and others.

The network interface 906 serves as an interface to a network, such as the Internet, to facilitate communication between the processor 902 and external devices, such as user devices previously discussed, by way of the network. As examples, the processor 902 may be configured to receive tags or codes of a textbook data object or portion thereof from authoring users via the network and network interface 906. Additionally, the processor 902 may transmit textbook source files or portions thereof to authoring and/or viewing users by way of the network interface 906 and network.

FIG. 10 illustrates a block diagram of an exemplary user device 1000 in accordance with another aspect of the disclosure. Any user device previously described herein may be configured similar to the exemplary user device 1000. The user device 1000 comprises a processor 1000, a memory device 1004, a user interface 1006, and a network interface 1008.

Similar to the processor 902 of the server 900, the processor 1002 performs the various operations of the user device 1000 under the control of one or more software modules stored in the memory device 1004. The one or more software modules may include a browser module to render a textbook data object on a user interface 1006, such as a display. The one or more software modules may include one or more of the aforementioned authoring modules, such as the textbook source file authoring module, question set authoring module, and animation authoring module. Such authoring modules may further be built as components of the browser module. A user using the user interface 1006, which may also comprise a keyboard and/or pointing device (e.g., a mouse, track ball, etc.), allows a user operate the browser module and/or one or more of the authoring modules.

Similar to the memory device 904 of the server 900, the memory device 1004 may store, in addition to the one or more software modules discussed above, data, such as data related to one ore textbook source files and/or one or more teaching objects. For instance, a user, through the use of the user interface (e.g., display, keyboard, pointing device, etc.), may view a textbook data object rendered by a browser module based on a textbook source file stored in the memory device 1004, the textbook source file being accessed by the processor 1002 via a network (e.g., the Internet) and the network interface 1008. Similarly, a user may edit a textbook source file or portion thereof (e.g., one or more teaching objects) using one or more of the authoring modules, wherein the one or more authoring module and/or textbook source file or portion being accessed by the processor 1002 via a network (e.g., the Internet) and the network interface 1008.

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. An apparatus for creating or modifying a source file comprising codes for instructing an authoring module how to create browser-renderable teaching objects including a browser-renderable animated teaching object configured to generate an animation, comprising:
a user interface; and
a processor configured to:
instruct the user interface to display a first input object configured to receive one or more inputs from a user to create one or more animation objects pertaining to the animated teaching object;
instruct the user interface to display a second input object for receiving one or more inputs from the user to create one or more animation instructions for the one or more animation objects pertaining to the animated teaching object; and
generate the codes associated with the one or more animation objects and the one or more animation instructions.

2. The apparatus of claim 1, wherein the processor is configured to instruct the user interface and generate the codes under a control of a browser module.

3. The apparatus of claim 1, wherein the processor is further configured to instruct the user interface to display the generated codes for copying and pasting to the source file.

4. The apparatus of claim 1, wherein the processor is configured to create or modify the source file based on the generated codes.

5. The apparatus of claim 1, wherein the one or more animation objects comprises a text object including text.

6. The apparatus of claim 5, wherein the processor is configured to instruct the user interface to display a third input object for receiving one or more inputs from the user to set one or more attributes of the text object.

7. The apparatus of claim 6, wherein the one or more attributes of the text object comprises one or more of the following:
a background color for a background upon which the text is overlaid;
a border color for a border surrounding the text;
an opacity for the text object;
a radius of corners of the border surrounding the text;
a position of the text object within a preview animation pane displayed by the user interface;
a font color for the text;
a font size for the text;
a font family for the text;
a text alignment for the text; and
a setting indicating whether to the text is italicized.

8. The apparatus of claim 1, wherein the one or more animation objects comprises a graphics object including a graphics design.

9. The apparatus of claim 8, wherein the processor is configured to instruct the user interface to display a third input object for receiving one or more inputs from the user to set one or more attributes of the graphics object.

10. The apparatus of claim 9, wherein the one or more attributes of the text object comprises one or more of the following:
a background color for a background upon which the graphics design is overlaid;
a border color for a border surrounding the graphics design;
an opacity for the graphics object;
a radius of corners of the border surrounding the graphics design; and
a position of the graphics object within a preview animation pane displayed by the user interface.

11. The apparatus of claim 1, wherein the one or more animation instructions comprises a move instruction for one of the animation objects.

12. The apparatus of claim 11, wherein the processor is configured to instruct the user interface to display a third input object for receiving one or more inputs from the user of an amount of movement of the animation object pursuant to the move instruction.

13. The apparatus of claim 12, wherein the third input object comprises:
a first input sub-object to receive a first value indicating a horizontal position within a preview animation pane to which the animation object is to be moved pursuant to the move instruction; and
a second input sub-object to receive a second value indicating a vertical position within the preview animation pane to which the animation object is to be moved pursuant to the move instruction.

14. The apparatus of claim 12, wherein the processor is configured to detect a select and drag of the animation object and a subsequent deselecting of the animation object, wherein the move instruction comprises moving the animation object to a position of the animation object at the unselecting of the animation object.

15. The apparatus of claim 1, wherein the one or more animation instructions comprises a fade instruction for one of the animation objects.

16. The apparatus of claim 15, wherein the processor is configured to instruct the user interface to display a third input object for receiving one or more inputs from the user of a degree of opacity for the animation object pursuant to the fade instruction.

17. The apparatus of claim 1, wherein the one or more animation instructions comprises a resize instruction for one of the animation objects.

18. The apparatus of claim 17, wherein the processor is configured to instruct the user interface to display a third input object for receiving one or more inputs from the user of first and second values indicating a new height and a new width for the animation object pursuant to the resize instruction.

19. The apparatus of claim 1, wherein the processor is configured to instruct the user interface to display a list of animation instructions in chronological order of execution pursuant to the animation.

20. The apparatus of claim 19, wherein the processor is configured to instruct the user interface to display a third input object for receiving one or more inputs from the user of a timing parameter associated with each of the animation instructions, the timing parameter specifying a timing for the execution of the corresponding animation instruction pursuant to the animation.

21. The apparatus of claim 19, wherein the processor is configured to instruct the user interface to display a third input object for receiving one or more inputs from the user for indicating a first set of the chronological animation instructions belonging to a first scene and a second set of the chronological animation instructions belonging to a second scene, wherein the animation is configured to stop at an end of the first scene and requires an input from a user to initiate a start of the second scene.

22. The apparatus of claim 19, wherein the processor is configured to instruct the user interface to display a static view of the animation in an animation preview pane in response to a selection action by the user of one of the animation instructions of the list, wherein the static view depicts the animation immediately after the execution of the selected animation instruction.

23. The apparatus of claim 19, wherein the processor is configured to instruct the user interface to display a third input object in response to a selection action by the user of one of the animation instructions of the list, wherein the third input object is configured to receive one or more inputs from the user of at least one attribute of the selected animation instruction.

24. The apparatus of claim 1, wherein the processor is configured to instruct the user interface to display a list of one or more references to the one or more animation objects, respectively.

25. The apparatus of claim 24, wherein the list includes references to a plurality of the animation objects illustrated as being stacked in a preview animation pane, and wherein an order of the references to the stacked objects are from most foreground to most background or from most background to most foreground.

26. The apparatus of claim 24, wherein the processor is configured to detect a select and drag of one of the references to the stacked animation objects within the list and a subsequent unselecting of the one of the references within the list by a pointing device of the user interface, the processor configured to instruct the display to change the viewing of the corresponding one of the stacked animation object based on a position within the list at which the unselecting of the one of the references was detected.

27. The apparatus of claim 24, wherein the processor is configured to detect a selection of one of the animation objects by detecting a selection of the reference to the one of the animation objects or by detecting a selection of the one of the animation objects in a preview animation pane.

28. The apparatus of claim 1, wherein the codes are configured to instruct the authoring module to configure the animated teaching object such that, when rendered by a browser module, a predetermined static view of the animation is provided prior to the animated teaching object being initiated, wherein the predetermined static view illustrates the animation immediately after or before the execution of a predetermined one of the animation instructions.

29. The apparatus of claim 1, wherein the processor is configured to instruct the user interface to display a third input object for receiving one or more inputs from the user to initiate a previewing of the animation in a preview animation pane.

30. The apparatus of claim 1, wherein the processor is configured to instruct the user interface to display a third input object for receiving a plurality of inputs from the user to initiate a previewing of a plurality of scenes of the animation in a preview animation pane, respectively.

31. An apparatus for creating or modifying a source file comprising codes for instructing an authoring module as to how to create browser-renderable teaching objects including a browser-renderable animated teaching object configured to generate an animation, comprising:
a user interface; and
a processor configured to:
instruct the user interface to display a first input object configured to receive the codes from a user, the codes are configured to create one or more animation objects and one or more animation instructions for the one or more animation objects pursuant to the animation;
instruct the user interface to display an animation preview pane for illustrating the animation based on the codes;
instruct the user interface to display an input object for receiving one or more modifications to the animation, wherein the one or more modifications comprises one or more of the following:
a modification of at least one attribute of the one or more animation objects;
a modification of at least one attribute of the one or more animation instructions;
a deletion of at least one of the one or more animation objects;
a deletion of at least one or more of the animation instructions;
an addition of at least one or more animation objects;
an addition of at least one or more animation objects;
modify the codes based on the one or more modifications, wherein the modified codes are used to create or modify the source file.
